(19) United States
(12) Patent Application Publication
(10) Pub. No.: US 2006/0281064 A1
(43) Pub. Date: Dec. 14, 2006

(54) Image communication system for compositing an image according to emotion input

(75) Inventors: Noriyuki Sato, Saitama (JP); Kazuhiro Ishikawa, Yamaguchi (JP); Mieko Tshikawa, Yamaguchi (JP); Seiji Inoue, Tokyo (JP)

Correspondence Address: VENABLE LLP, P.O. BOX 34385, WASHINGTON, DC, 20043-9998, US

(73) Assignee: Oki Electric Industry Co., Ltd., Tokyo (JP)

(21) Appl. No.: 11/439,351

(22) Filed: May 24, 2006

(30) Foreign Application Priority Data
May 25, 2005 (JP) 2005-151855

(51) Int. Cl. G09B 5/00

(52) U.S. Cl. 434/308

(57) ABSTRACT

In an image communication system for compositing and generating an image for enhancing the communication, a composite image generator in a communication terminal analyzes voice data and image data, and an analyzer analyzes voice data to detect an emotion parameter. Basic emotion data are generated by a movement controller, an emotion movement pattern storage and a basic emotion generator, based on the emotion parameter. An expression compositor composites the basic emotion data with expression data, extracted from image data, to generate composite expression data. An image compositor composites the composite expression data with character data to generate a composite character image.

### BACKGROUND OF THE INVENTION

1. Field of the Invention

The present invention relates to an image compositing apparatus for compositing and generating an image for communications, in an image-oriented telecommunications system, such as a video phone or a video chat. The present invention also relates to a communication terminal and an image communication system, employing the apparatus, and to a chat server in the system.

2. Description of the Background Art

In a conventional image transmission system, exploiting an information terminal device fitted with an image communication function, as disclosed in Japanese patent No. 3593067, the terminal device is supplied with an image including a face image, and sends model data consistent with expressions of the face image for enhancing the communications. Since it is not image data but feature point data of the face that is transmitted, protection of privacy on the part of the transmitting side user may be assured, while an image may be received which is high in entertainment performance.

On the other hand, in an image transmission system, disclosed in Japanese patent application No. 2004-381300, movie data, complying with an image communication platform, such as a format for video or mobile phone, is transmitted and received for communications to reduce the cost for system construction. The system provides for higher entertainment performance by generating movie data based on user controllable basic expression data.

In an image generating device, disclosed in Japanese patent laid-open publication No. 2005-38160, in which image data, voice data and key operations are analyzed to detect parameters, complying with expressions, and an image is composited based on the so detected parameters, higher functionality and entertainment performance are achieved.

In a face information transmission system, disclosed in United States patent application publication No. US 2004/0207720 A1, a character image is transmitted, expression data is detected based on input image data and voice data, and a command concerning the expressions is input based on an interrupt command. A character image is generated responsive to these expression data and the command concerning the expressions. By so doing, such an image may be generated in which there are reflected such elements as the user's emotion or intention.

In the face information transmission system of the above United States patent application publication No. US 2004/0207720 A1, for example, character images are generated based on image data, voice data and an interrupt command. Since the interrupt command is needed for having the user's emotion or intention reflected in the image, the user has to perform more operations in order to generate an image higher in functionality or in entertainment performance.

In utilizing an image communication system, the user intends to achieve higher communications through a video phone or video chat. It is difficult that the user has to exploit many functions as he or she is communicating, such that onus felt by the user is necessarily increased.

### SUMMARY OF THE INVENTION

It is an object of the present invention to provide an image compositing apparatus for compositing and generating an image for communications, a communication terminal and an image communication system, employing the apparatus, and a chat server in the system, in which an image oriented for communications is composited and generated on the basis of the information the user has entered for communications, without entailing special operations on the part of the user in the course of communications.

In accordance with the present invention, there is provided an image compositing apparatus for generating a composite image based on input information from a user, in which voice data corresponding to voice uttered by the user is input as the input information. The apparatus comprises an emotion analyzer for detecting a predetermined emotion parameter based on processed voice data obtained on subjecting the voice data to signal processing, an emotion movement pattern storage for storing a plurality of emotion movement patterns related to a plurality of the emotion parameters, a movement controller for referencing the emotion movement pattern storage to detect a predetermined emotion movement pattern related to the predetermined emotion parameter, and an image compositor for modifying predetermined character data based on the predetermined emotion movement pattern to generate a composite character image.

In accordance with the present invention, there is also provided an image compositing apparatus for generating a composite image based on the input information from a user, in which text data related to text input by the user is input as the input information. The apparatus comprises an emotion analyzer for detecting text data, related to text input by the user, as the input information, an emotion movement pattern storage for storing a plurality of emotion movement patterns related to the emotion parameters, a movement controller for referencing the emotion movement pattern storage to detect a predetermined emotion movement pattern relating to the predetermined emotion parameter, and an image compositor for modifying predetermined character data based on the predetermined emotion movement parameter to generate a composite character image.

Further in accordance with the present invention, there is also provided a communication terminal for transmitting or receiving a voice signal and an image signal over a communication network, such as IP (Internet Protocol) network, for communications. The communication terminal comprises a communication circuit connected over the IP network, to another communication terminal, as a counterpart of communication, for transmitting or receiving the voice signal and the image signal, a voice input device for inputting voice data, corresponding to utterances by the user, as the input information, an emotion analyzer for detecting a predetermined emotion parameter based on processed voice data which is the voice data processed with signal processing, an emotion movement pattern storage for storing a plurality of emotion movement patterns related with a plurality of emotion parameters, a movement controller for referencing emotion movement pattern storage to detect a predetermined emotion movement pattern, related with the predetermined emotion parameter, and an image compositor for modifying predetermined character data, based on the predetermined emotion parameter, to generate a composite character image. The composite character image and the voice data are encoded to generate the voice signal and the image signal for transmission. The voice signal and the image signal, received by the communication circuit, are decoded to generate received voice data and received image data. The received voice data and received image data are provided to the user.

Still in accordance with the present invention, there is also provided a communication terminal for transmitting or receiving a voice signal and an image signal over a communication network, such as IP (Internet Protocol) network, for communications. The communication terminal comprises a communication circuit connected over the IP network to another communication terminal, as a counterpart of communication, for transmitting or receiving a voice signal and an image signal, an input device for inputting text data, corresponding to the text input by the user, as the input information, an emotion analyzer for detecting a predetermined emotion parameter based on the text data, an emotion movement pattern storage for storing a plurality of emotion movement patterns related to the emotion parameters, a movement controller for referencing the emotion movement pattern storage to detect a predetermined emotion movement pattern, related with the predetermined emotion parameter, and an image compositor for modifying predetermined character data based on the predetermined emotion movement pattern to generate a composite character image. The composite character image and the voice data are encoded to generate the voice signal and the image signal for transmission. The voice signal and the image signal, received by the communication circuit, are decoded to generate received voice data and received image data. The received voice data and received image data are provided to the user.

Still further in accordance with the present invention, there is also provided a communication terminal for transmitting or receiving a voice signal and an image signal over a communication network, such as IP network, for communications. The communication terminal comprises a communication circuit connected over the IP network to another communication terminal, as a counterpart of communication, for transmitting or receiving the voice signal and then image signal, a voice input device for inputting voice data, corresponding to utterance by the user, as the input information, an emotion analyzer for detecting a predetermined emotion parameter based on processed voice data obtained on processing the voice data, an emotion movement pattern storage for storing a plurality of emotion movement patterns related to the emotion parameters, a movement controller for referencing the emotion movement pattern storage to detect a predetermined emotion movement pattern, related with the predetermined emotion parameter, and a control packet generator for packetizing a control parameter for modifying predetermined character data, detected based on the predetermined emotion movement pattern, to generate a control packet. The communication circuit transmits or receives the control packet as the image signal. The communication terminal further includes an image compositor for modifying predetermined character data, based on the control parameter extracted from the control packet received by the communication circuit to thereby generate a composite character image. The voice data is encoded to generate the voice signal and the image signal for transmission. The voice signal received by the communication circuit is decoded to generate received voice data. The received voice data and the composite character image are provided to the user.

Further in accordance with the present invention, there is also provided a communication terminal for transmitting or receiving a voice signal and an image signal over a communication network, such as IP network, for communications. The communication terminal comprises a communication circuit connected over the IP network to another communication terminal, as a counterpart of communication, for transmitting or receiving a voice signal and an image signal, a text input device for inputting text data, related to the text input by the user, as the input information, an emotion analyzer for detecting a predetermined emotion parameter based on the text data, an emotion movement pattern storage for storing a plurality of emotion movement patterns related to the emotion parameters, a movement controller for referencing the emotion movement pattern storage to detect a predetermined emotion movement pattern, related with the predetermined emotion parameter, and a control packet generator for packetizing a control parameter for modifying predetermined character data, detected based on the predetermined emotion movement pattern, to generate a control packet. The communication circuit transmits or receives the control packet as the image signal. The communication terminal further includes an image compositor for modifying predetermined character data, based on a control parameter extracted from the control packet received by the communication circuit to generate a composite character image. The voice data is encoded to generate the voice signal for transmission. The voice signal received by the communication circuit is decoded to generate received voice data. The received voice data and received composite character data are provided to the user.

In accordance with the present invention, there is also provided a communication system employing a plurality of communication terminals for transmitting or receiving a voice signal and an image signal over a communication network, such as IP network, for communications. Predetermined one of the communication terminals includes a communication circuit connected over the IP network to another communication terminal, as a counterpart of communication, for transmitting or receiving a voice signal and an image signal, a voice input device for inputting voice data, corresponding to utterance by the user, as the input information, an emotion analyzer for detecting a predetermined emotion parameter based on processed voice data obtained on processing the voice data with signal processing, an emotion movement pattern storage for storing a plurality of emotion movement patterns related to the emotion parameters, a movement controller for referencing the emotion movement pattern storage to detect a predetermined emotion movement pattern, related with the predetermined emotion parameter, and an image compositor for modifying predetermined character data, based on the predetermined emotion movement pattern, to generate a composite character image. The composite character image and the voice data are encoded to generate the voice signal and the image signal for transmissions. The voice signal and the image signal, received by the communication circuit, are decoded to generate received voice data and received image data. The received voice data and received image data are provided to the user.

Further in accordance with the present invention, there is also provided an image communication system employing a plurality of communication terminals for transmitting or receiving a voice signal and an image signal over a communication network, such as IP network, for communications. Predetermined one of the communication terminals comprises a communication circuit connected over the IP network, to another communication terminal as a counterpart of communication, for transmitting or receiving a voice signal and an image signal, voice input device for inputting voice data, related to utterance by the user, as the input information, an emotion analyzer for detecting a predetermined emotion parameter based on the processed voice data which is the voice data processed with signal processing, an emotion movement pattern storage for storing a plurality of emotion movement patterns related to the emotion parameters, a movement controller for referencing the emotion movement pattern storage to detect a predetermined emotion movement pattern, related with the predetermined emotion parameter, and an image compositor for modifying predetermined character data, based on the predetermined emotion movement pattern, to generate a composite character image. The composite character image and the voice data are encoded to generate the voice signal and the image signal for transmission. The voice signal and the image signal, received by the communication circuit, are decoded to generate received voice data and received image data. The received voice data and received image data are provided to the user.

Still further in accordance with the present invention, there is also provided an image communication system for transmitting or receiving a voice signal and an image signal over a communication network, such as IP network, for communications. Predetermined one of the communication terminals includes communication circuit connected over the IP network to another communication terminal, as a counterpart of communication, for transmitting or receiving a voice signal and an image signal, voice input device for inputting voice data, corresponding to utterance by the user, as the input information, an emotion analyzer for detecting a predetermined emotion parameter based on processed voice data which is the voice data processed with signal processing, an emotion movement pattern storage for storing a plurality of emotion movement patterns related to the emotion parameters, a movement controller for referencing the emotion movement pattern storage to detect a predetermined emotion movement pattern, related with the predetermined emotion parameter, and a control packet generator for packetizing a control parameter modifying predetermined character data, detected based on the predetermined emotion movement pattern, to generate a control packet. The communication circuit transmits or receives the control packet as the image signal. The predetermined communication terminal further includes an image compositor for modifying predetermined character data, based on a control parameter extracted from the control packet received by the communication circuit to thereby generate a composite character image. The voice data is encoded to generate the voice signal for transmission. The voice signal, received by the communication circuit, is decoded to generate received voice data. The received voice data and the composite character image data are provided to the user.

Still in accordance with the present invention, there is also provided an image communication system employing a plurality of communication terminals for transmitting or receiving a voice signal and an image signal over a communication network, such as IP network, for communications. Predetermined one of the communication terminals includes a communication circuit connected over the IP network to another communication terminal, as a counterpart of communication, for transmitting or receiving a voice signal and an image signal, a text input device for inputting text data, related to the text input by the user, as the input information, an emotion analyzer for detecting a predetermined emotion parameter based on the text data, an emotion movement pattern storage for storing a plurality of emotion movement patterns related to the emotion parameters, a movement controller for referencing the emotion movement pattern storage to detect a predetermined emotion movement pattern, related with the predetermined emotion parameter, and a control packet generator for packetizing a control parameter modifying predetermined character data, detected based on the predetermined emotion movement pattern, to generate a control packet. The communication circuit transmits or receives the control packet as the image signal. The predetermined communication terminal includes image compositor for modifying predetermined character data, based on a control parameter extracted from the control packet received by the communication circuit to thereby generate a composite character image. The voice data is encoded to generate the voice signal for transmission and the voice signal received by the communication circuit are decoded to generate received voice data. The received voice data and composite character image data are provided to the user.

Further in accordance with the present invention, there is also provided a chat server arranged on an image communication system employing a plurality of communication terminals for transmitting or receiving voice and image signals over a communication network, such as IP network, to communicate with one another. The chat server sets up a chat session with the communication terminals. The chat server comprises a session manager for managing and processing the chat session, a filter for referencing the chat session for extracting a user identification (ID) identifying a user of predetermined chat data and message data of the user, an emotion analyzer for detecting a predetermined emotion parameter based on the message data, and a control letter generator for generating a predetermined control code matched to the predetermined emotion parameter. The session manager merges the predetermined control code to the predetermined chat data to send the predetermined chat data to the communication terminals taking part in the chat session.

With the image compositing apparatus of the present invention, in which the emotion analyzer analyzes voice data to detect an emotional parameter, a basic emotion ID as set in the emotion movement pattern storage is acquired, depending on the emotion parameter, and character data is composited, using the basic emotion data matched to the basic emotion ID, a composite character image, matched to the emotion, may automatically be generated without alienated feeling on the part of the user. Since key operations or the operations of intentionally inputting registered image or voice patterns are unneeded, the user does not have to perform laborious inputting operations. By setting basic emotions, images with enhanced expressions may be generated to achieve functions which are high in entertainment performance.

With the image compositing apparatus of the present invention, control of the viewing point, selection of the background image or the launching of the fixed-form animation may be made responsive to emotion parameters, so that zoom control, switching of the background image or furnishing the fixed-form animation, which are high in entertainment performance, may be performed in keeping with ups and downs of the user's emotion, without imposing excessive work load on the user.

Moreover, with the image compositing apparatus of the present invention, in which text data input by the user using a text input device, such as text chat, is entered, an emotion analyzer analyzes the text data to detect the emotion parameters, representing the user's emotion, the user may execute fixed-form animation as he or she uses text chat. Hence, the text chat may be improved in entertainment performance without imposing work load on the user.

With the image communication system, to which is connected a communication terminal provided with the image compositing apparatus, the provision of a chat server with the emotion analyzer requires no dictionary included in each communication terminal for defining the correspondence between text data necessary for emotion analysis and the emotion, thereby reducing the cost in constructing a system.

With the image compositing apparatus of the present invention, the emotion movement pattern table may be adjusted in desired manner by the emotion movement pattern setting section, thus achieving movements more in meeting with the user's intention. On the other hand, the character manager is provided to load down new character data for updating. The emotion movement pattern table may be updated for realizing the movements consistent with the new character data, for enhancing the entertainment performance responsive to the user's commands.

Moreover, in the image communication system having plural communication terminals connected, any of the aforementioned image compositing apparatuses may be used in the communication terminal to transmit and receive composite character images generated. Hence, it is possible to achieve communications high in entertainment performance.

Additionally, with the image communication system, according to the present invention, a predetermined communication terminal packetizes expression data indicating feature quantities of feature points of a face image in image data, and the control information, such as viewing point control, consistent with the emotion parameter is packetized and sent to other communication terminals. The receiving communication terminal generates a composite character image based on the expression data and the control information. Hence, there may be provided a multi-functional communication system in which the quantity of communication is decreased and the user may be relieved of excess inputting operations.

### BRIEF DESCRIPTION OF THE DRAWINGS

The objects and features of the present invention will become more apparent from consideration of the following detailed description taken in conjunction with the accompanying drawings in which:

FIG. 1 is a schematic block diagram showing an embodiment of an image communication system according to the present invention;

FIG. 2 shows examples of an emotion movement pattern in the image communication system shown in FIG. 1;

FIG. 3 is a flowchart useful for understanding an operational sequence of a communication terminal in the image communication system shown in FIG. 1;

FIG. 4 is a schematic block diagram showing an alternative embodiment of a composite image generator in the image communication system shown in FIG. 1;

FIG. 5 shows examples of emotion movement patterns in the composite image generator shown in FIG. 4;

FIG. 6 is a schematic block diagram showing another embodiment of a composite image generator in the image communication system according to the present invention;

FIG. 7 shows examples of emotion movement patterns in the composite image generator shown in FIG. 6;

FIGS. 8 and 9 are schematic block diagrams showing alternative embodiments of an image communication system according to the present invention;

FIG. 10 is a schematic block diagram showing another alternative embodiment of a communication terminal in the image communication system according to the present invention; and

FIGS. 11 and 12 are schematic block diagrams showing further alternative embodiments of an image communication system according to the present invention.

### DESCRIPTION OF THE PREFERRED EMBODIMENTS

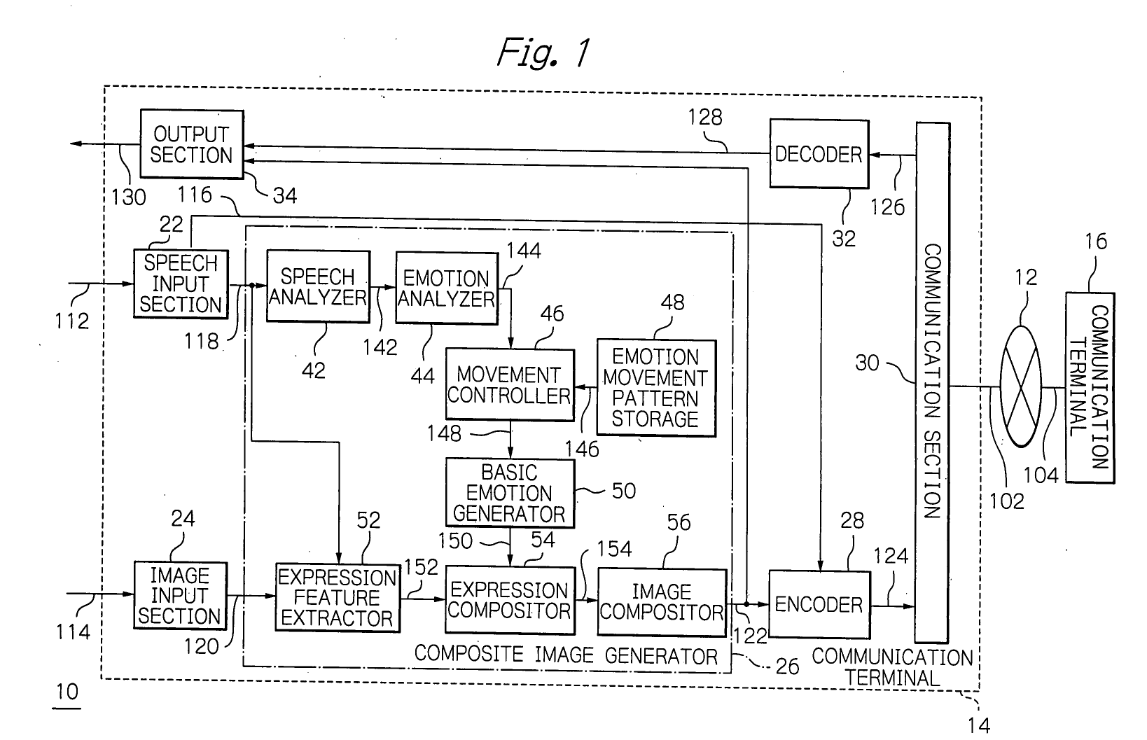

With reference to the accompanying drawings, preferred embodiments of an image communication system of the present invention will be described in detail. As shown in FIG. 1, an image communication system 10 of the instant embodiment is structured for reciprocally transmitting and receiving communication data, for example, character data in the time domain, between plural communication terminals 14 and 16, over an IP (Internet Protocol) network 12. The communication terminal 14 is adapted to generate composite image data in a composite image generator 26, based on voice data and image data, obtained in a voice input section 22 and an image input section 24, respectively, and output the voice data and the composite image data via an encoder 28 and a communication section 30 to the IP network 12. The communication terminal is also adapted to send out data, received via a communication section 30 and a decoder 32 over the IP network 12, via an output section 34 to a user. For simplicity, parts or components in the system not directly related to understanding the present invention will neither be described nor shown.

In the image communication system 10 of the instant embodiment, a plural number of communication terminals 14 and 16 are connected to the IP network 12 over communication lines 102 and 104, respectively. However, a variety of other communication circuit, such as wireless connections, may also be used.

In the instant embodiment, the image communication system 10 may include a larger number of telecommunications terminals connected one to another. In FIG. 1, only two communication terminals 12 and 14 are depicted for avoiding complexity in illustration.

The image communication system 10 includes at least one communication terminal 14 having a composite image generator 26. On the other hand, the image communication system 10 may include a communication terminal 16 not having the composite image generator 26. In the communication terminal 16, image data 120 from the image input section 24 may directly be sent in the form of composite image data 122 to the encoder 28.

For example, the communication terminal 14 of the instant embodiment may be connected to a voice detector, such as a microphone, by means of which the communication terminal may be supplied with a voice signal 112 representative of the voice uttered by the user. The terminal 14 is also interconnected to an imaging device such as a solid-state image sensor adapted for producing an image signal 114. The communication terminal 14 may also be adapted to output data 130 from the output section 34 to an output device, such as a display device, so as to be supplied to the user employing his or her own terminal. The communication terminal 14 may also be structured to include the voice detector, the image sensor and an output device as built-in devices.

The voice input section 22 in the communication terminal 14 has the function as an input interfacing circuit supplied with a voice signal 112. In an application supplied for example with an analog voice signal 112, the voice input section 22 is adapted to transform the signal by analog-to-digital conversion to generate digital voice data 118 which is then output to the composite image generator 26 and to the encoder 28.

The image input section 24 in the communication terminal 14 has the function of an input interfacing circuit supplied with the image signal 114 including a face image. In an application supplied with the analog image signal 114, for example, the image input section 24 is adapted for transforming the image signal 114 by analog-to-digital conversion to generate the digital image data 120 which is then output to the composite image generator 26.

In the present embodiment, the composite image generator 26 is adapted to analyze the voice data 118 by a voice analyzer 42 and an emotion analyzer 44 to detect emotion parameters 144, to detect an emotion movement pattern 148, based on emotion parameters 144 by a movement controller 46 and an emotion movement pattern storage 48, to generate basic emotion data 150, based on an emotion movement pattern 148, by a basic emotion generator 50, to extract expression data 152 based on the image data 120 by an expression feature extractor 52, to composite composites basic emotion data 150 and expression data 152 by an expression compositor 54 to generate composite expression data 154, and to composite predetermined character data and composite expression data 154 by an image compositor 56 to generate composite image data 122.

The encoder 28 is adapted to encode the voice signal 112 and composite image data 122 to generate transmission data 124 which is then supplied to the communication section 30. The encoding by the encoder 28 may be effected in accordance with a predetermined encoding algorithm, such as MPEG (Motion Picture Coding Experts Group) or ITU (International Telecommunication Union)—T Recommendations (Telecommunication Standardization Sector) H.26x Series. The decoder 32 is adapted for decoding reception data 126, supplied over the communication section 30, to send output data 128, such as decoded voice or image data, to the output section 34.

The communication section 30 has an interfacing function for connection to the IP network 12. In the present embodiment, the communication section 30 is connected to the IP network 12 over the communication line 102 to the IP network 12. Alternatively, the connection may be established by a wireless interface, such as electro-magnetic waves.

The communication section 30 sends transmission data 124 from the encoder 28 over the IP network 12 to another communication terminal, while receiving data transmitted from another communication terminal to send received data 126 to the decoder 32.

The output section 34 is configured to be supplied from the decoder 32 with data 128 for voice or images transmitted from a peer terminal, such as other communication terminal 16, and with composite image data 122 generated by the composite image generator 26 of the own terminal 14. The output section 34 transforms the input data into data 130 presentable to the user to output the so transformed data.

Moreover, the voice analyzer 42 in the composite image generator 26 of the present embodiment is adapted for executing signal processing, such as frequency or power analysis, on the voice data 118 supplied from the voice input section 22. The voice analyzer 42 routes the so processed voice data 142 to the emotion analyzer 44.

The emotion analyzer 44 serves as detecting the emotion parameters 144, based on voice characteristics of voice data 142 from the voice analyzer 42. In the present embodiment, the emotion analyzer 44 detects the emotion parameters 144, including the emotion ID (Identification) and emotion strength, to send the so detected emotion parameters 144 to the movement controller 46.

For example, the emotion analyzer 44 is able to separate the voice data 142 on the frame basis, on the time axis, to find out the power deviation among these frames, an average value of the power differences and the deviation of the power differences to extract the information pertinent to the emotion, such as emotion patterns or the degree of excitement. The emotion analyzer 44 is then able to detect the emotion parameters 144, inclusive of the emotion ID and the emotion strength, based on the so extracted information. The emotion analyzer 44 may also use means for extraction other than those given above in order to detect the emotion parameters 144.

The movement controller 46 is responsive to the emotion parameters 144 from the emotion analyzer 44 to acquire an emotion movement pattern 146, including the basic emotion ID, from the emotion movement pattern storage 48, to send the basic emotion ID 148 to the basic emotion generator 50. Using the emotion ID and the emotion strength of the emotion parameters 144, as a key, the movement controller 46 of the instant embodiment references the emotion movement pattern storage 48 to acquire the emotion movement pattern 146.

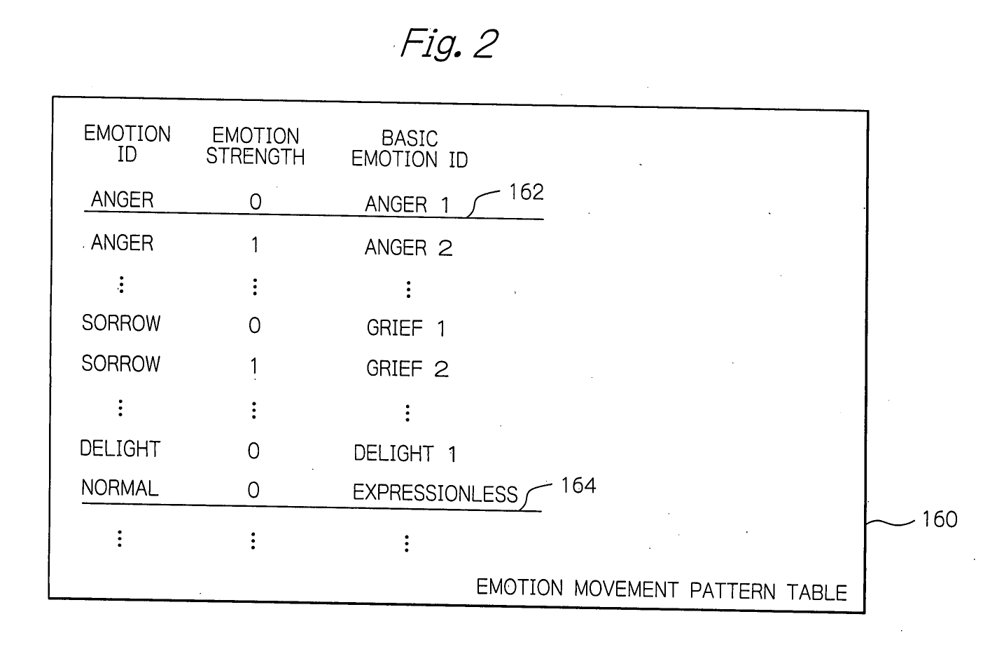

The emotion movement pattern storage 48 may be made up by a memory, such as RAM (Random Access memory), adapted for holding an emotion movement pattern table 160. The emotion movement pattern table 160 holds the combination of the emotion IDs, emotion strength and the basic emotion IDs, as shown for example in FIG. 2. If the emotion ID of the emotion parameter 144 is ‘anger’ and the emotion strength is ‘0’, for example, the emotion movement pattern storage 48 references the corresponding combination 162 in the emotion movement pattern table 160. This gives the ‘anger 1’ as the basic emotion ID representing the basic emotion, including delight, anger, sorrow and pleasure.

The basic emotion generator 50 serves as generating the basic emotion data 150, representing basic emotion, such as delight, anger, sorrow and pleasure, to the expression compositor 54, based on the basic emotion ID 148 from the movement controller 46. The basic emotion data are feature point data representing feature quantities of feature points of a face image. Preferably, generated are the basic emotion data 150 of the same data format as that of the expression data 152, generated by the expression feature extractor 52. Also preferably, the basic emotion generator 50 may hold basic emotion data in association with each basic emotion ID.

The expression feature extractor 52 functions as extracting expression data 152, as feature point data representing feature quantities of feature points of a face image, based on the voice data 118 from the voice input section 22 and from the image data 120 from the image input section 24, to route the so extracted data to the expression compositor 54. For example, the expression feature extractor 52 decides on feature points of a face from the face image indicated on the image data 120 to extract the expression data 152 which are in keeping with their feature quantities. The expression feature extractor 52 may use both the voice data 118 and the image data 120 to generate the expression data 152, or may use one of the voice data 118 and the image data 120 to generate the expression data 152.

When using the voice data 118, the expression feature extractor 52 may process the threshold value of the voice waveform in the voice data 118 to extract the expression data 152, so that, if the voice value is above a predetermined threshold value, the mouth is opened or an eyebrow is raised, and so that, if the voice value is below a predetermined threshold value, the mouth is closed or an eyebrow is lowered.

When using the image data 120, the expression feature extractor 52 may detect edges in the face image in the image data 120 and may extract the contours of eyes, nose, mouth and eyebrows, from the so detected edge, to extract the expression data 152 from the quantity of movement of coordinate data of the feature points obtained on the basis of these contours.

The expression feature extractor 52 may also use means, different from the above extraction means, in order to extract the expression data 152.

The expression compositor 54 has the function of compositing the basic emotion data 150 from the basic emotion generator 50 and the expression data 152 from the expression feature extractor 52 to generate the composite expression data 154 which is routed to the image compositor 56. If the basic emotion data 150 and the expression data 152 represent movement quantities from the expressionless state, the expression compositor 54 may simply add these movement quantities to generate the composite expression data 154. Alternatively, the expression compositor 54 may use other means to extract the composite expression data 154.

The image compositor 56 serves as compositing predetermined character data and the expression data 154 from the expression compositor 54 to generate a composite character image to supply the encoder 28 with the composite character image data 122 representative of the character composite image. In the instant embodiment, the image compositor 56 holds such predetermined character data in its memory. The image compositor 56 may allow an external agent to set character data to provide for character data interchangeability.

The image compositor 56 may use model data, such as wire frames, formed by plural polygons, as character data, and change the polygon forming position in the model data responsive to coordinate data indicated by the composite expression data 154. The image compositor 56 may then execute rendering for the so changed model data in order to generate a composite character image 122 in which predetermined character data have been changed based on composite expression data 154.

The image compositor 56 may also send the generated composite character image 122 to the output section 34 in order to confirm the composite character image 122 transmitted by the user.

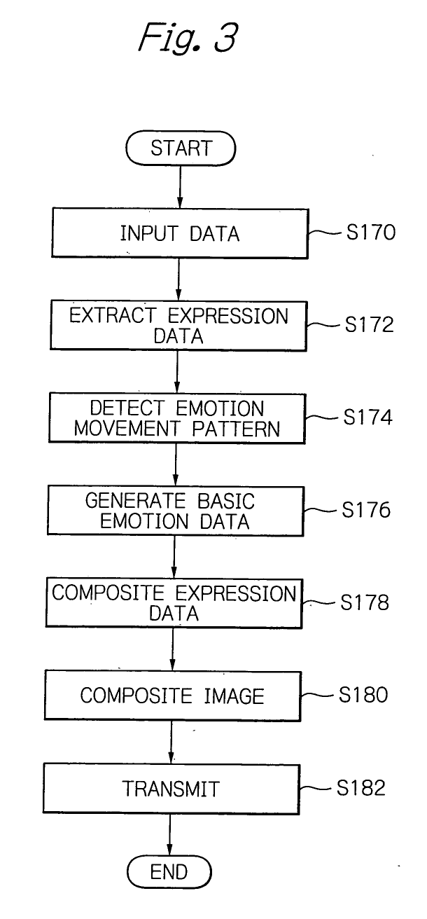

In operation, the image communication system 10 of the instant embodiment proceeds the operation of transmitting data by a user, which will now be described with reference to a flowchart of FIG. 3.

When a data transmitting operation is commenced in the image communication system 10 of the instant embodiment, a user enters the voice signal 112 and the image signal 114, as the input information for initiating the communication, in the voice input section 22 and in the image input section 24 in the communication terminal 14 (step S170).

This voice signal 112 is converted by the voice input section 22 into the voice data 118, which is then routed to the composite image generator 26. The image signal 114 is converted by the image input section 24 into the image data 120, which is then routed to the composite image generator 26.

The image data 120 is routed to the expression feature extractor 52 of the composite image generator 26, where the expression data 152, which are based on the image data 120, are extracted and routed to the expression compositor 54 (step 172).

In the composite image generator 26, the voice data 118 are processed with voice analysis, and the voice data 142, which are based upon the voice data 118, are detected. The voice data 142 are processed with emotion analysis by the emotion analyzer 44 to detect emotion parameters 144 which are based upon the voice data 142 (step S174). The emotion parameters 144 are routed to the movement controller 46.

The movement controller 46 then references an emotion movement pattern table in the emotion movement pattern storage 48 where a basic emotion ID 148 related to the emotion parameter 144 is detected and routed to the basic emotion generator 50. The basic emotion generator 50 generates the basic emotion data 150, representing the basic emotion, based on the basic emotion ID 148. The basic emotion data 150 is routed to the expression compositor 54 (step S176).

The expression compositor 54 generates composite expression data 154, based on the basic emotion data 150 and the expression data 152, and routes the so generated data to the expression compositor 54 (step S178).

The image compositor 56 generates the composite image data 122 by compositing predetermined character data and composite expression data 154. The so generated data is sent to the encoder 28 (step S180).

Transmission data for the composite image data 122, generated in this manner by the composite image generator 26, are generated by the encoder 28 and the communication section 30, and sent to other communication terminals over IP network 12 (step S182).

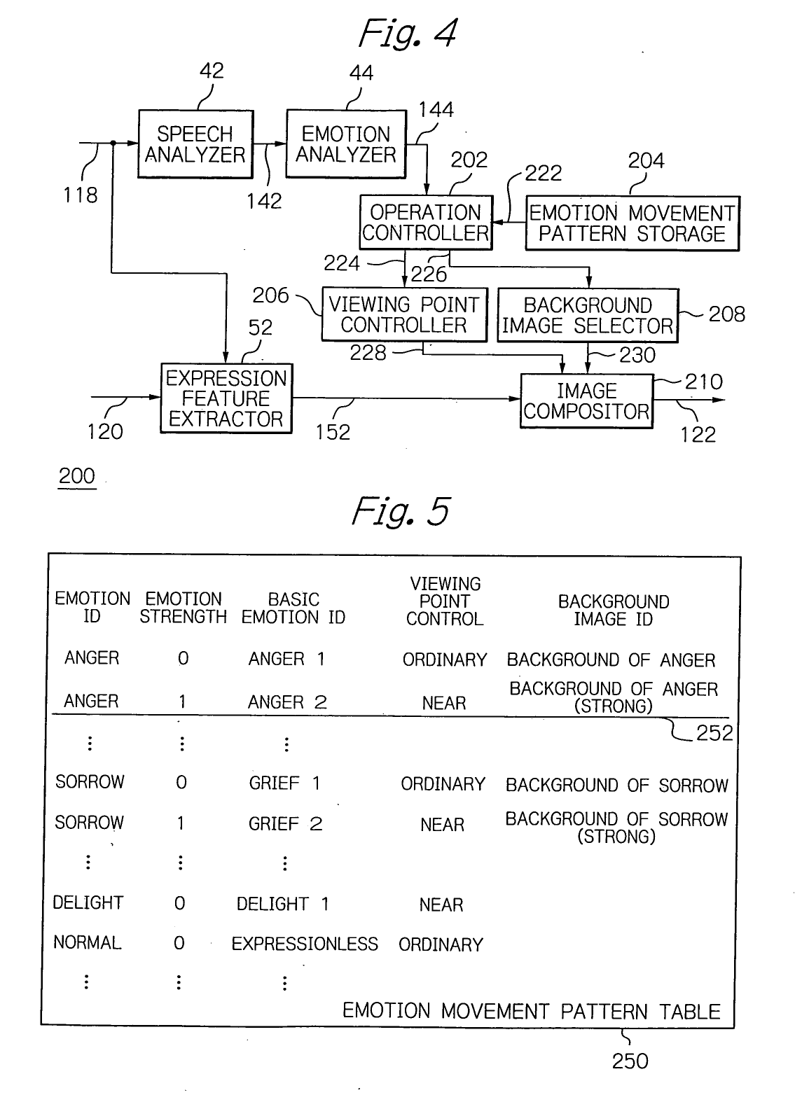

Referring to FIG. 4, showing an alternative embodiment, a composite image generator 200 in the communication terminal 12 is adapted to detect an emotion movement pattern 222 including a viewing point control ID 224 and a background image ID 226 by an operation controller 202 and an emotion movement pattern storage 204, based on emotion parameters 144 from the emotion analyzer 44, to detect viewing point parameters 228 by a viewing point controller 206, based on the viewing point control ID 224, to detect a background image parameter 230 by a background image selector 208, based on the background image ID 226, and to composite predetermined character data by an image compositor 210, based on expression data 152 from the expression feature extractor 52, viewing point parameters 228 and the background image parameter 230 to generate composite image data 122.

The operation controller 202 is adapted to acquire the emotion movement pattern 222, including the viewing point control ID and the background image ID, from the emotion movement pattern storage 204, responsive to the emotion parameters 144 from the emotion analyzer 44. The operation controller 202 sends the viewing point control ID 224 and the background image ID 226 to the viewing point controller 206 and to the background image selector 208. Similarly to the movement controller 46, the operation controller 202 references the emotion movement pattern storage 204, using the emotion ID and the emotion strength of the emotion parameters 144, as a key, to acquire the emotion movement pattern 222.

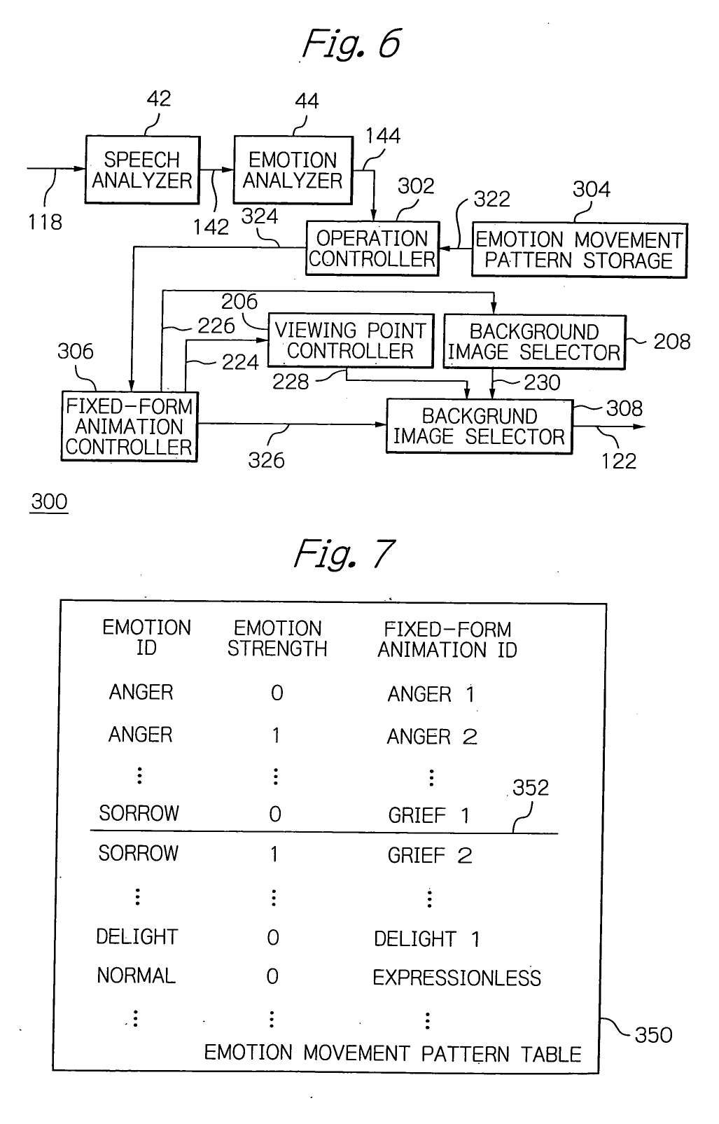

Similarly to the emotion movement pattern storage 48, the emotion movement pattern storage 204 may be formed by a memory device adapted for holding an emotion movement pattern table. An emotion movement pattern table 250 holds data of the emotion ID, emotion strength, viewing point control ID and background image ID, in combination, as shown for example in FIG. 5. If, for example, the emotion ID of the emotion parameters 144 is ‘anger’ and the emotion strength is ‘0’, the emotion movement pattern storage 204 references a corresponding combination 252 in the emotion movement pattern table 250, so that ‘near’ and ‘background of anger (strong)’ are acquired as viewing point control ID and background image ID, respectively.

For example, the emotion movement pattern table 250 in the emotion movement pattern storage 204 preferably sets the respective combinations so that the viewing point will be nearer as the emotion strength is increasing. It is however possible to set the combination having other relationships.

The viewing point controller 206 functions as generating the viewing point parameters 228, used at the time of generating a composite character image, based on the viewing point control ID 224 from the operation controller 202, to route the so generated viewing point parameters 228 to the image compositor 210. Preferably, the viewing point controller 206 is adapted to generate the viewing point parameters 228, represented by the three-dimensional world coordinate or by a relative coordinate with respect to characters. The viewing point parameters 228 may also be generated so as to be inclusive of changes in the angle of field. The viewing point controller 206 may hold the viewing parameters in association with each viewing point control ID.

The background image selector 208 is adapted for sending the background image parameter 230, representing the background image, to the image compositor 210, based on the background image ID 226 from the operation controller 202. The background image selector 208 may hold, from the outset, a background image related to each background image ID.

The image compositor 210 may be configured similarly to the image compositor 56 to composite predetermined character data and the composite expression data 152 from the expression feature extractor 52 to generate a composite character image. In the instant embodiment, in particular, the image compositor 210 generates composite image data 122 in such a manner that a composite character image will be drawn based on the viewing point parameters 228 from viewing point controller 206 and on the background image parameter 230 from the background image selector 208.

The image compositor 210 generates the composite image data 122 so that, when the viewing point parameters 228 indicates ‘near’, the predetermined character data is enlarged, and so that, when the background image parameter 230 indicates the ‘background of anger (strong)’, such a background which will give an impression stronger than with the usual ‘background of anger’ will be used in the combination. For example if the usual ‘background of anger’ indicates arrows of lightning to express the anger, the ‘background of anger (strong)’ may be the background with larger numbers of arrows of lightning or with lightning changed in color.

The composite image generator 200 may be configured so as to be inclusive of the basic emotion generator 50 and the expression compositor 54. In this case, expression compositing processing, employing the basic emotion data 150 for the expression data 152, may be applied to generate expression data 152 to send composite expression data 154 to the image compositor 210 where the character data is composited with the composite expression data 154.

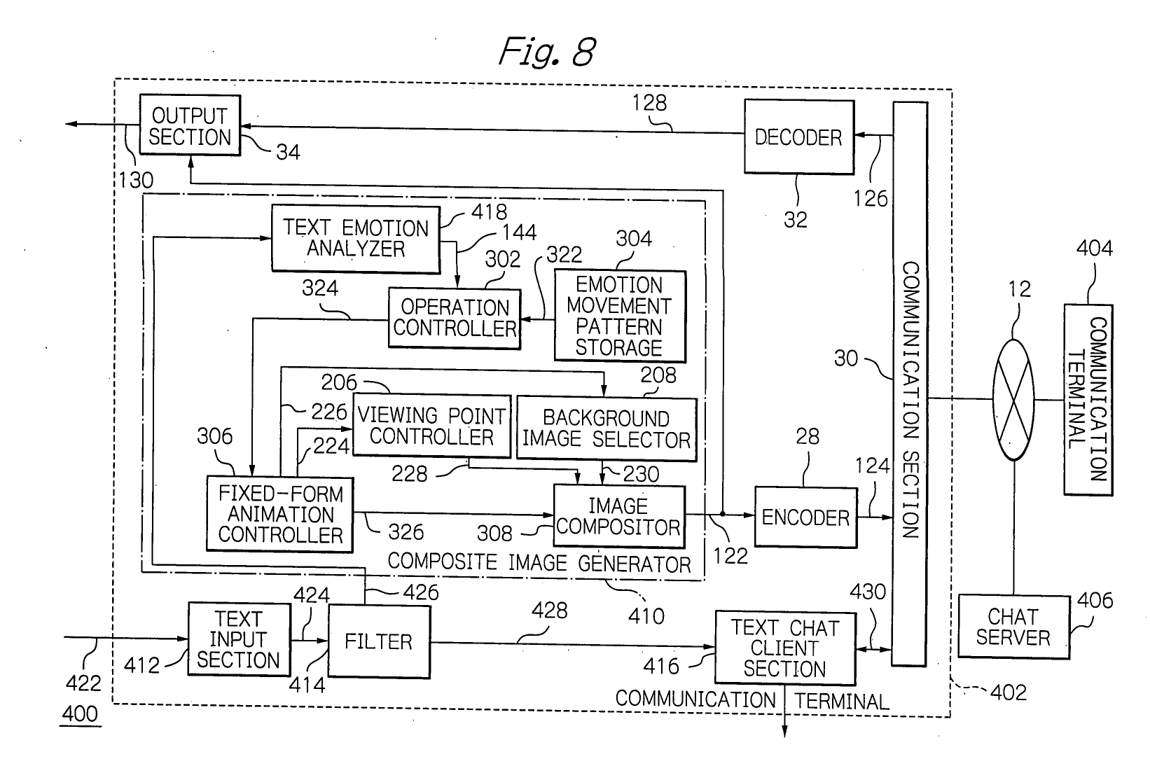

Referring now to FIG. 6, showing an alternative embodiment, a composite image generator 300 in a communication terminal 12 is adapted to detect an emotion movement pattern 322, inclusive of a fixed-form animation ID 324, by an operation controller 302 and an emotion movement pattern storage 304, to acquire animation data, inclusive of expression data, viewing point control ID 224 and background image ID 226 by a fixed-form animation controller 306, based on this animation ID 324, to detect viewing point parameters 228 by the viewing point controller 206, based on the viewing point control ID 224, to detect the background image parameter 230 by the background image selector 208, based on the background image ID 226, and to composite predetermined character data by an image compositor 308, based on expression data 326 from the fixed-form animation controller 306, viewing point parameters 228 and the background image parameter 230, to generate a composite image data 122.

The operation controller 302 is responsive to the emotion parameters 144 from the emotion analyzer 44 to acquire the emotion movement pattern 322 inclusive of the fixed-form animation ID 324 to send the fixed-form animation ID 324 to the fixed-form animation controller 306. Similarly to the movement controller 46, the operation controller 302 references the emotion movement pattern storage 304, with the emotion ID and the emotion strength of the emotion parameter 144 as a key, to acquire the emotion movement pattern 322.

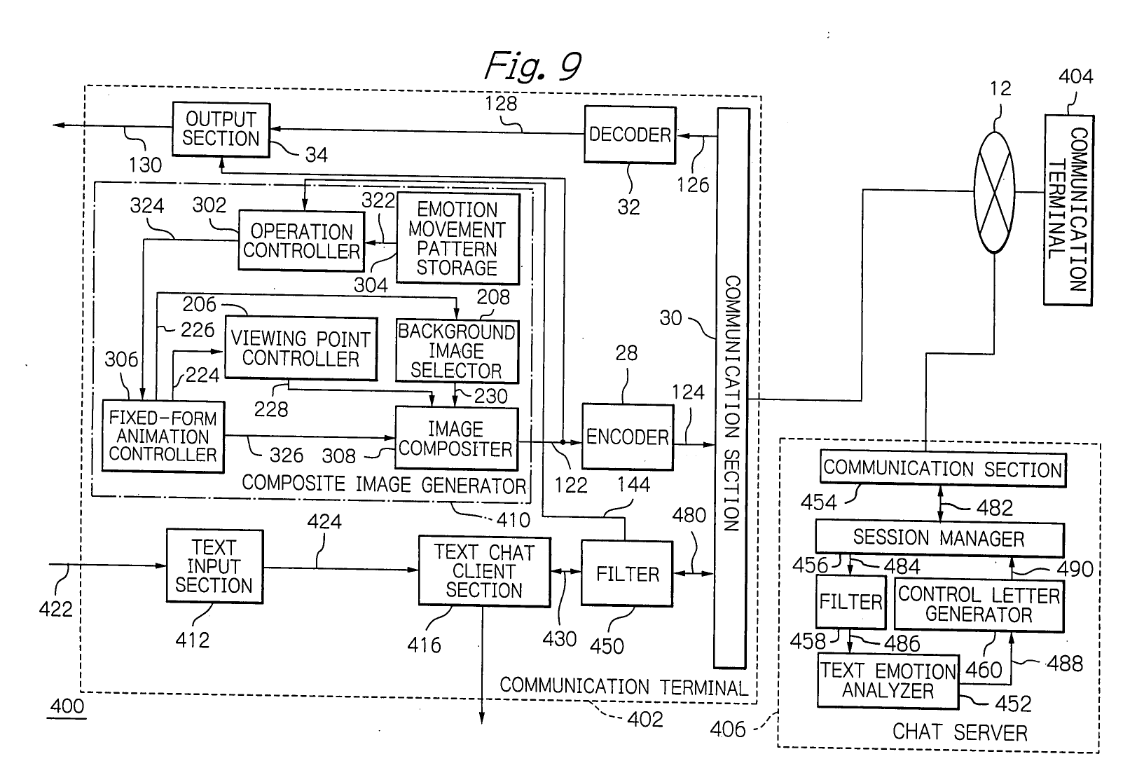

The emotion movement pattern storage 304 may be made up by a memory device adapted for holding an emotion movement pattern table 350. The emotion movement pattern table holds the combination of the emotion IDs, emotion strength and the fixed-form animation IDs, as shown in FIG. 7. For example, if the emotion ID of the emotion parameters 144 is ‘sorrow’ and the emotion strength is ‘0’, the emotion movement pattern storage 304 references the corresponding combination 352 in the emotion movement pattern table 350. This gives the ‘grief 1’ as the fixed animation ID.

The fixed animation controller 306 functions as providing the image compositor 308, viewing point controller 206 and the background image selector 208 with expression data 326, viewing point control ID 224 and the background image ID 226, as animation data, respectively, during the animation reproducing time, based on the fixed-form animation ID 324 from the operation controller 302. The animation reproducing time may be fixed irrespective of the fixed-form animation ID, or may be set from one fixed-form animation ID to another.

The fixed animation controller 306 of the present embodiment serves as holding animation data, related to each fixed-form animation ID, from the outset. In more detail, the fixed animation controller 306 holds the combination of expression data along the time axis, viewing point control ID and the background image ID. The fixed-form animation controller 306 may also deal with expression data including not only feature points of the face, but also body movements, expressing the emotion, such as movements of hands or neck, as expression data.

The fixed-form animation controller 306 sends the expression data, viewing point control ID 224 and the background image ID 226, associated with the fixed-form animation ID 324 on the time axis, sequentially to the image compositor 308, the viewing point controller 206 and the background image selector 208. However, if the image represented by the background image ID 226 is not changed along the time axis, the fixed-form animation controller 306 does not have to output the background image ID 226 at each image update-timing in the image compositor 308, but only has to send the background image ID only once to the background image selector 208. That is, only an ID which will cause an image to be changed may be supplied at each image update timing.

The image compositor 308 may be configured similarly to the image compositor 210 to generate a composite character image modified from predetermined character data, based on the expression data 326 from the fixed-form animation controller 306, viewing point parameters 228 from the viewing point controller 206 and on the background image parameter 230 from the background image selector 208, in order to output composite image data 122.

The composite image generator 300 of the present embodiment may deal with animation data including the basic emotion ID in animation data. In this case, the fixed-form animation controller 306 may hold the basic emotion ID related to each fixed-form animation ID, and the composite image generator 300 may include the basic emotion generator 50 and the expression compositor 54. The fixed-form animation controller 306 may send the basic emotion ID to the basic emotion generator 50 responsive to the fixed-form animation controller 306. The basic emotion generator 50 may then output basic emotion data, related with the basic emotion ID, to the expression compositor 54. The expression compositor 54 may composite the basic emotion data and the expression data 326 from the fixed-form animation controller 306 to generate composite expression data. The image compositor 308 may then generate composite character data based on this composite expression data.

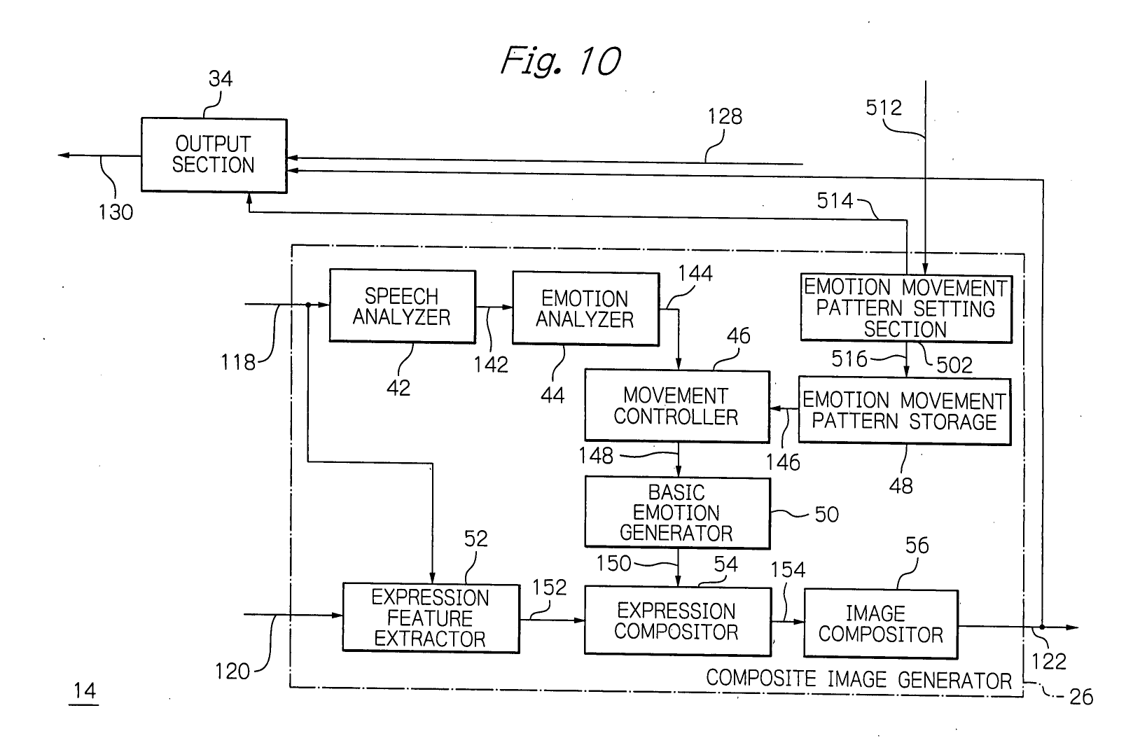

In a further alternative embodiment, an image communication system 400 is connected over IP network 12 to plural communication terminals 402 and 404, as shown in FIG. 8. In particular, a chat server 406 is connected to the IP network 12 to construct a chat session between each communication terminal and the chat server 406.

The communication terminal 402 may be constructed similarly to the communication terminal 14 in any of the above-described embodiments. In particular, in the present embodiment, the communication terminal 402 includes a text input section 412, a filter 414 and a text chat client 416, and has the chat function of transmitting and receiving text data to and from the chat server 406. The filter 414 extracts a message part in chat data from the text input section 412 to send the extracted text data to a composite image generator 410. The composite image generator 410 is responsive to this message to modify character data to produce a composite character image 122. Meanwhile, the configuration of the communication terminal 402, which is the same as that of the communication terminal 14, will not be described herein specifically.

In the alternative embodiment, the image communication system 400 includes at least one communication terminal 402 provided with a composite image generator 410. By contrast, the system may include a communication terminal 404 not provided with the composite image generator 410. In such a communication terminal 404, there may be provided the image input section 24, and the image data 120 may directly be sent as composite character image 122 to the encoder 28.

In the present alternative embodiment, the composite image generator 410 serves as analyzing message data 426 from the filter 414 by a text emotion analyzer 418 to detect emotion parameters 144. The configuration up to generation of the composite image data 122 based on the emotion parameters 144 may be the same as that of the composite image generator 26, 200 or 300. Thus, in FIG. 8, the composite image generator 410 may be configured similarly to the composite image generator 300, that is, may be provided with the operation controller 302, the emotion movement pattern storage 304, the fixed-form animation controller 306, the viewing point controller 206, the background image selector 208 and with the image compositor 308.

The text emotion analyzer 418 functions as analyzing the emotion represented by letters or characters, input as text. Specifically, it analyzes the message data 426 coming from the filter 414 to detect the emotion parameters 144.

The text emotion analyzer 418 of the instant alternative embodiment includes a dictionary for correlating letter or character strings with different sorts of the emotion, and references this dictionary to verify whether or not each word in the message data 426 represents predetermined emotion. When a word in the data 426 represents predetermined emotion, the text emotion analyzer 418 detects the emotion ID, related with the emotion, and counts the emotion IDs, obtained on verifying all words of the message data 426, from one sort of the emotion to another, to detect the number of times of occurrence of the emotion IDs. The text emotion analyzer 418 sets the emotion ID, which occurred most frequently, as being the emotion ID for the message data 426, and decides on the emotion strength from the number of times of the occurrence of the emotion ID for the message data 426. The text emotion analyzer 418 detects the emotion parameters 144 including these emotion IDs and the emotion strength.

For example, in an application in which the letters or words “On again” are stored in the dictionary in association with the emotion ID ‘pleasure’, if the words “On again” are contained in the message data 426, then the number of times of occurrence of the emotion ID ‘pleasure’ is incremented by one.

The text emotion analyzer 418 may weight each letter or character string, stored in the dictionary, with a number representing the weight proper to a word, and store the so weighted letter or character. In this case, when verifying the message data 426, the text emotion analyzer 418 may calculate the sum total of the weights of the respective emotion IDs, as detected, to decide on the emotion ID for the message data 426 and the emotion strength.

The text emotion analyzer 418 may also store the emotion IDs and the number of times of occurrence thereof in the past message data as an input history. It is possible to detect more preferred emotion IDs and the number of times of occurrence thereof by referencing a past history to verify the emotion IDs and the numbers of times of occurrence thereof in the current message data 426.

The text emotion analyzer 418 may also be configured for exploiting the results of syntactic analysis of the message data 426.

The text input section 412 serves as accepting chat data 422 indicating letters or characters which a user enters in a text chat. The chat data 424 is supplied to the filter 414. The filter 414 sends chat data 426 from the text input section 412 to the text chat client 416. In the present embodiment, the filter 414 extracts in the chat data 424 message data 428 corresponding to a message part to send the latter to the text emotion analyzer 418.

The text chat client 416 is connected over a connection line 430 to the communication section 30 to set up chat session with the chat server 406 to enable communication with another communication terminal. Specifically, the text chat client 416 maintains the session with the chat server 406 to provide the user with the chat function. The text chat client 416 performs customary text chat client processing, such as chat data transmission and reception with the chat server 406, and is formed by software, for example.

When the communication terminal 402 sends chat data, the text chat client 416 provides the communication section 30 with chat data 430. The communication section 30 forms the chat data 430 into, for example, a data packet, which is sent over IP network 12 to the chat server 406.

In the communication terminal 402 of the instant alternative embodiment, the text emotion analyzer 418 analyzes text data, input by the user as text, with the aid of the chat function. It is however possible for the text emotion analyzer 418 to analyze text data, input with the aid of other text input devices.

The image communication system 400 may also be provided with a text emotion analyzer 452, in the chat server 406, as shown in FIG. 9. When sending a message, supplied from a transmitting side communication terminal, to a receiving side communication terminal, taking part in the chat session, the chat server 406 detects a control code from this message, in the text emotion analyzer 452, and sends the control code to the receiving side communication terminal, along with the message.

In the case where the chat server 406 is provided with the text emotion analyzer 452 as such, the communication terminal 402 is provided with the filter 450, as shown in FIG. 9. When chat data is received from the transmitting side communication terminal, the filter 450 may extract a control code from chat data. The emotion parameter indicated by this control code may be supplied to the operation controller 302 to control the composite image generator 410. The communication terminal 402 need not be provided with the filter 414 nor with the text emotion analyzer 418.

When the communication terminal 402 sends chat data, the filter 450 sends chat data 430 from the text chat client 416 directly to the communication section 30. When the communication terminal 402 has received the chat data, the communication terminal checks whether or not a control code, which has encoded emotion parameters, such as emotion ID or emotion strength, is contained in the chat data, in addition to sending the chat data 480, transmitted from another terminal and sent from the communication section 30, directly to the text chat client 416.

When the filter 450 has detected a control code from the chat data 480, the filter 450 decodes the control code to send emotion parameters 144, such as emotion ID or emotion strength, to the operation controller 302.

The filter 450 may also be adapted to send to the text chat client 416 chat data 430 obtained on filtering the chat data 480 received from the communication section 30 to remove the control code. The chat data 480 received from the communication section 30 may also be directly sent to the text chat client 416, which text chat client 416 then disregarding the control code.

The chat server 406 of the instant alternative embodiment, thus provided with the text emotion analyzer 452, is also provided with a communication section 454, a session manager 456, a filter 458 and a control letter generator 460.

The communication section 454 is adapted to receive chat data 482, sent from the communication terminal, as a data packet, and send the chat data 482 to the session manager 456, while sending chat data 482, supplied from the session manager 456, to the communication terminal.

The session manager 456 is adapted for supervising and processing the chat session. In particular, in the present embodiment, the manager 456 has the function of sending a string of letters/characters, transmitted and received in the chat session, that is, chat data 484 from the users, to the filter 458. The session manager 456 also merges a control code 490, supplied from the control letter generator 460, to chat data which forms the source of the control code 490, in the chat session, to form a data packet composed of the control code 490 merged to the chat data. The session manager 456 sends the so formed data packet over communication section 454 to communication terminals taking part in the chat session.

The filter 458 extracts the user ID and the message data from the chat data 484, on the user-by-user basis, and routes the message data 486 to the text emotion analyzer 452.

The text emotion analyzer 452 may be configured similarly to the text emotion analyzer 418. The text emotion analyzer 452 analyzes the message data 486, on the user-by-user basis, to detect emotion parameters, such as emotion ID or emotion strength, to send the emotion parameters 488 detected to the control letter generator 460.

The control letter generator 460 functions as converting the emotion parameters 488 into a corresponding code to thereby generate a control code 490, and send the so generated control code 490 to the session manager 456 along with the corresponding user ID.

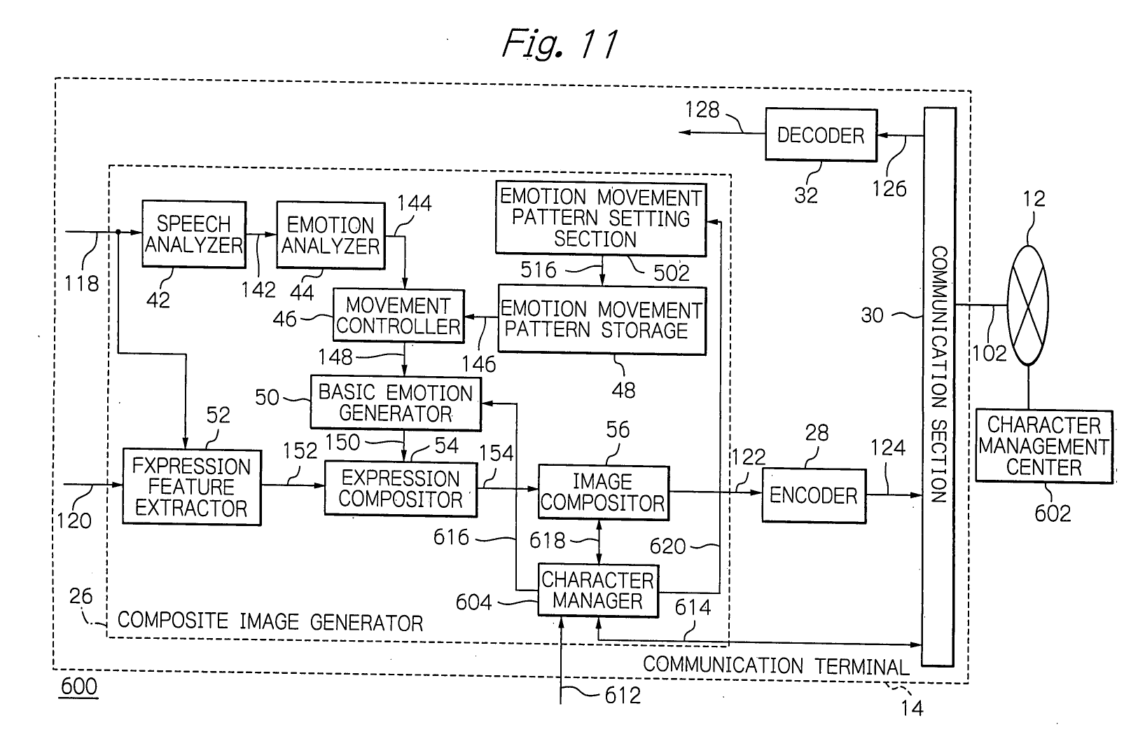

In a still further alternative embodiment, the composite image generator 410 is provided with an emotion movement pattern setting section, as shown in FIG. 10, and is able to rewrite an emotion movement pattern table in an emotion movement pattern memory, in accordance with a user's command. FIG. 10 shows a configuration of the composite image generator 26 in which an emotion movement pattern setting section 502 is connected to the emotion movement pattern storage 48 to rewrite the emotion movement pattern table in the emotion movement pattern storage 48. A similar configuration may also be used in the composite image generator 200, 300 or 410.

In the present alternative embodiment, if a user is desirous to rewrite the emotion movement pattern table 160 in the emotion movement pattern storage 48, then an emotion movement pattern designating signal 512, instructing this rewriting, is input to the composite image generator 26. The emotion movement pattern setting section 502 in the composite image generator 26 outputs a rewrite command signal 516 to the emotion movement pattern storage 48, responsive to the emotion movement pattern designating signal 512, to rewrite the emotion movement pattern table 160.

The emotion movement pattern setting section 502 is also responsive to the emotion movement pattern designating signal 512 to send to the output section 34 an emotion pattern indicating signal 514, which will indicate the post-rewrite emotion movement pattern setting picture, to supply the user with this setting picture. Although the emotion movement pattern table 160, as the emotion movement pattern setting picture, may be arranged in variegated formats, an emotional pattern table, shown for example in FIG. 2, may be displayed in a format shown therein.

The output section 34 is responsive to the emotion pattern indicating signal 514 to issue output data 130 displaying an emotion movement pattern setting picture to provide the user with the emotion movement pattern setting picture, which the user will in turn reference to thereby enable the user to perform a setting operation of rewriting the emotion movement pattern.

The emotion movement pattern designating signal 512, input to the emotion movement pattern setting section 502, may be a signal produced responsive to the user's actuation on a user interface, such as GUI (Graphic User Interface) provided on an external device connected to the communication terminal 14. Thus, when the user references the emotion movement pattern setting picture to rewrite the emotion movement pattern, the emotion movement pattern designating signal 512, indicating the rewriting of the emotion movement pattern table, is produced responsive to this setting operation, and input to the emotion movement pattern setting section 502.

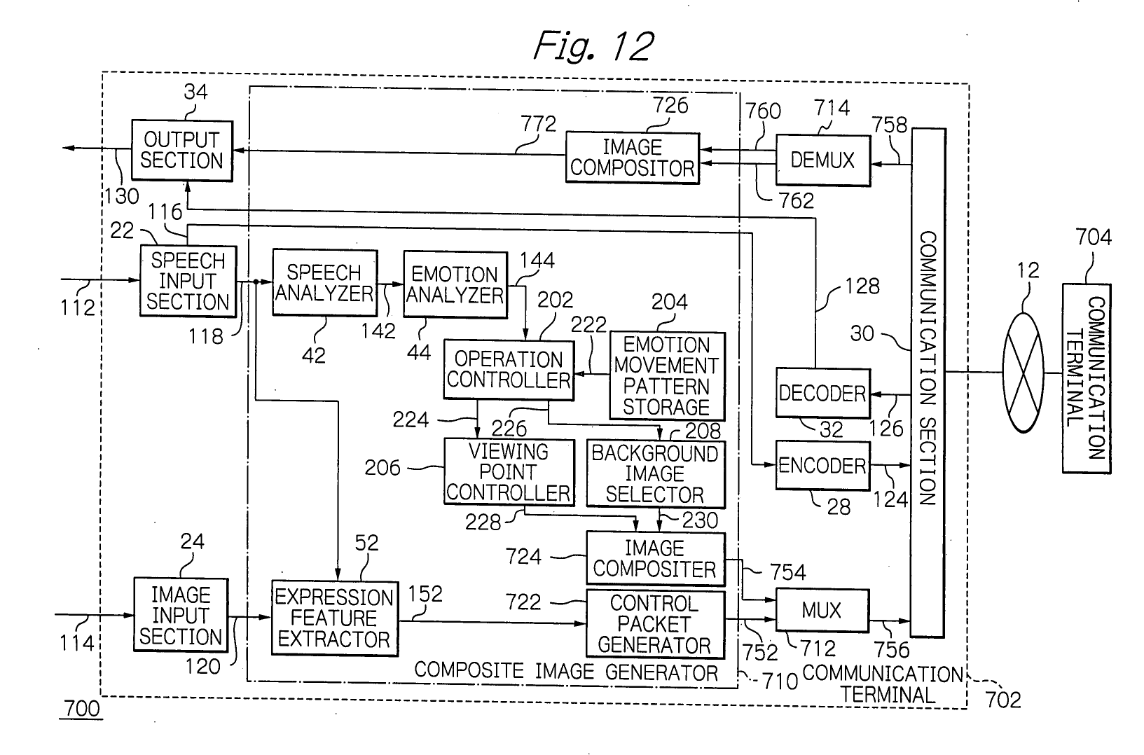

In a still another alternative embodiment, the composite image generator in the communication terminal 14 of an image communication system 600 may be provided with a character manager, supervising character data update operations, in order to set an emotion movement pattern, consistent with updated character data, in an emotion movement pattern setting section, as shown in FIG. 11. Although FIG. 11 shows an illustrative structure in which a character manager 604 is included in the composite image generator 26, similar structures may also be used in the composite image generator 200, 300 or 410.

In the present alternative embodiment, the IP network 12 of the image communication system 600 is connected to a character management center 602, having plural character data, as shown in FIG. 11. For example, if the communication terminal 14 has issued a command to the character management center 602, over IP network 12, to download predetermined character data, it may be obtain the character data.

The communication terminal 14 may be configured and operated similarly to the communication terminal 14 or 402 in any of the above-described embodiments. The present embodiment includes, in particular, the composite image generator 26 having the character manager 604. As for the same configuration as that of the communication terminals in the above-described embodiments, reference is made to the corresponding description and detailed description with reference to FIG. 11 will be dispensed with.

The character manager 604 has the function of downloading character data. In the present alternative embodiment, the character manager 604 has the function of communicating with the character management center 602, via communication section 30 and IP network 12. Thus, the character manager 604 may send a control signal 614, instructing the downloading of the character data, to the character management center 602 to download character data therefrom.

The character manager 604 receives a control signal 612, instructing the downloading of character data, responsive to a user's actuation, to send the control signal 614, instructing the downloading of the character data, to the communication section 30, responsive to this control signal 612. Since the download command, indicated by the control signal 614, is notified via communication section 30 and IP network 12 to the character management center 602, the character management center 602 sends the character data, related with the control signal 612, via the IP network 12 and the to the communication section 30, to the character manager 604.

The character manager 604 has the function of holding the character data, downloaded from the character management center 602, in its memory, and updating any of stored character data for use in the image compositor 56.

The character manager 604 receives a control signal 612, as an update command signal for the character data, responsive to the user's actuation, to update the character data indicated by this control signal 612 as character data used in the image compositor 56. At this time, the character manager 604 sends, as the information related to the character data indicated by this control signal 612, basic emotion parameters 616, such as basic emotion ID or basic emotion data, to the basic emotion generator 50. The character manager 604 also sends, as the information related to the character data indicated by this control signal 612, character data parameters 618, such as apex point information, texture information or modified parameters of the characters, and an emotion movement pattern table 620, to the image compositor 56 and to the emotion movement pattern setting section 502, respectively, to update the information stored therein. The emotion movement pattern setting section 502 rewrites the emotion movement pattern table 160 in the emotion movement pattern storage 48 to an emotion movement pattern table 516.

Thus, with the composite image generator of the present invention, provided with the character manager 604, character data may be downloaded and updated responsive to user's actuations.

In a further alternative embodiment, an image communication system 700 is adapted to permit image-free communication data to be transmitted between plural communication terminals 702 and 704, as shown in FIG. 12, and the communication terminal 702 is adapted to produce, when transmitting communication data, an expression packet 752 and a control packet 754 by a composite image generator 710, and to concatenate the packets by a multiplexer (MUX) 712 to transmit resulting packet data, obtained on the multiplexing, via communication section 30 over the IP network 12 to the other communication terminal 704. The communication terminal 702 is further adapted to receive, when receiving communication data, packet data 758 transmitted from the other communication terminal 704 over the IP network 12, by the communication section 30, to extract an expression packet 760 and a control packet 762 by a demultiplexer (DEMUX) 714 from the packet data 758, and to produce image data 772 by the composite image generator 710, based on the expression packet 760 and the control packet 762 to send it to the output section 34 for provision to the user.

In the present alternative embodiment, the image communication system 700 may be arranged such that larger numbers of communication terminals are arranged and interconnected. However, in FIG. 12, only two communication terminals 702 and 704 are shown for avoiding complexity. The peer communication terminal 704 needs to be constructed similarly to the communication terminal 702.

The communication terminal 702 may be configured and operated similarly to the communication terminal 14 or 402 in any of the above-described embodiments. However, the present alternative embodiment includes, above all, the composite image generator 710, the multiplexer 712 and the demultiplexer 714. The configuration similar to the communication terminal in the above-described embodiments will not repetitively be described in detail with reference to FIG. 12 for avoiding redundancy.

Referring now to FIG. 12, the composite image generator 710 includes an expression packet generator 722 and a control packet generator 724 respectively adapted to produce the expression packet 752 and the control packet 754, respectively, to route them to the multiplexer 712. The image generator 710 also includes an image compositor 726 adapted to generate image data 772, based on an expression packet 760 and a control packet 762, to route the data to the output section 34.

The expression packet generator 722 is supplied with expression data 152 from the expression feature extractor 52 to generate the expression packet 752 based on the expression packet 152. The expression packet generator 722 may be designed to form n frames of the expression data 152 into a communication packet, where n stands for an integer not less than zero.

The control packet generator 724 may be designed to generate the control packet 754, based on the viewing point parameters 228 from the viewing point image controller 206 an on the background image parameter 230 from the background image selector 208. The control packet generator 724 may be designed to form m frames of the viewing point parameters 228 and the background image parameter 230 into a communication packet, where m stands for an integer not less than zero.

The control packet generator 724 may also generate the control packet 754, using a background ID as the background image parameter 230, thereby decreasing the volume of packet data transmitted or received.

The image compositor 726 functions as generating the image data 772, based on the expression packet 760 and the control packet 762 from the demultiplexer 714, to route the data 772 to the output section 34.

The image compositor 726 is configured similarly to the image compositor 210 to composite predetermined character data with expression data represented by the expression packet 760 to generate a composite character image. Additionally, the image compositor 726 generates composite image data 772, which will render a composite character image based on the viewing point parameter and the background image parameter indicated by the control packet 762.

Preferably, the image compositor 726 may be designed to hold plural background images in advance to select the background images responsive to the background image ID which is the background image parameter.

In FIG. 12, the composite image generator 710 may include the voice analyzer 42, the emotion analyzer 44, the expression feature extractor 52, the operation controller 202, the emotion movement pattern storage 204 and the viewing point controller 206 to obtain the expression data, the viewing point parameter and the background image parameter. However, the composite image generator 710 may also be configured similarly to the composite image generator 200, 300 or 410 to obtain the expression data, the viewing point parameter and the background image parameter.

For example, the composite image generator 710 may include the expression compositor 54 and supply the composite expression data 154 to the expression packet generator 722 to generate the expression packet 752 based on the composite expression data 154. The composite image generator 710 may also include the fixed-form animation controller 306 and supply the expression data 326 to the expression packet generator 722 to generate the expression packet 752 based on the expression data 326.

The composite image generator 710 may also include the emotion movement pattern setting section 502 and the character manager 604 to render rewritable the emotion movement pattern table in the emotion movement pattern storage 48.

The multiplexer 712 concatenates the expression packet 752 with the control packet 754 to form packet data 756 from the composite image generator 710 to send the packet data 756 over the communication section 30 and the IP network 12 to the other communication terminal 704.

The demultiplexer 714 is supplied with the packet data 758, transmitted from the other communication terminal 704 over the IP network 12 and the communication section 30, and extracts the expression packet 760 inclusive of the expression data and the control packet 762 inclusive of the viewing point parameter and the background image parameter, to route the thus extracted packets to the image compositor 726 of the composite image generator 710.

The multiplexer 712 may also be designed to send the packet data 756 to the demultiplexer 714 of the own terminal 702. In such a case, responsive thereto, the demultiplexer 714 and the image compositor 726 of the composite image generator 710 may be in operation to transmit the image data 772 to the output section 34. Thus, the user may be supplied with the image from the output section 34 to confirm the composite image he/she transmitted. The demultiplexer 714, the image compositor 726 and the output section 34 may be operated in such a manner that the composite image transmitted from the own terminal 702 will be sent simultaneously with the composite image received from another terminal.

The composite image generator 710 in the communication terminal 702 may also send the packet data 756 to the image compositor 726, before packetizing the viewing point parameter and the background image parameter, without supplying the packet data 756 from the multiplexer 712 to the demultiplexer 714 of the own terminal 702.

In the instant alternative embodiment, the communication terminal 702 does not transmit images. Hence, the encoder 28 may receive only voice data 118 from the voice input section 22 and encode the received data. Also, with the decoder 32 of the alternative embodiment, only voice data 128 is obtained on decoding data 126 supplied from another terminal 704. This voice data 128 is sent to the output section 34.

Meanwhile, according to the present invention, the composite image generator in any of the above-described embodiments may be separated to form an independent unit, such as an image compositor unit.

Moreover, with the image compositing apparatus, the communication terminal and the image communication system, according to the present invention, the functions of controlling the basic emotion or the viewing point, switching the background images or controlling the startup control of the fixed-form animation may be selectively combined with each other, provided that emotion movement patterns may be set in the emotion movement pattern storage in dependence upon the combination.

Additionally, with the image communication system of the present invention, the functions of character selection or guidance, or the license management method may be combined with one another or with a toll system in a desired manner.

The entire disclosure of Japanese patent application No. 2005-151855 filed on May 25, 2005, including the specification, claims, accompanying drawings and abstract of the disclosure is incorporated herein by reference in its entirety.

While the present invention has been described with reference to the particular illustrative embodiments, it is not to be restricted by the embodiments. It is to be appreciated that those skilled in the art can change or modify the embodiments without departing from the scope and spirit of the present invention.

What is claimed is:

1. An image compositing apparatus for generating a composite image based on input information from a user, wherein voice data related to voice uttered by the user is input as the input information, said apparatus comprising:
an emotion analyzer for detecting a predetermined emotion parameter based on processed voice data obtained on subjecting the voice data to signal processing;
an emotion movement pattern storage for storing a plurality of emotion movement patterns related to a plurality of emotion parameters;
a movement controller for referencing said emotion movement pattern storage to detect a predetermined emotion movement pattern related to the predetermined emotion parameter; and
an image compositor for modifying predetermined character data based on the predetermined emotion movement pattern to generate a composite character image.

2. The image compositing apparatus in accordance with claim 1 wherein said emotion movement pattern storage stores a basic emotion identification, for identifying the basic emotion, such as delight, anger, sorrow and pleasure, as the emotion movement pattern, in association with the emotion parameter;
said movement controller detecting a predetermined basic emotion identification related to the predetermined emotion parameter;
said apparatus further comprising:
an image input device for inputting image data, including a face image of the user, as the input information;
an expression feature extracting circuit for extracting predetermined expression data, representing the expressions of the face image of the user, based on the voice data and/or the image data, the predetermined expression data being feature point data representing feature quantities of feature points of a face image;
a basic emotion generator for storing basic emotion data representing the emotion indicated by the basic emotion identification, and for detecting predetermined basic emotion data which is based upon the predetermined basic emotion identification, the basic emotion data being the feature point data; and
an expression compositor for compositing the predetermined expression data with the predetermined basic emotion data to generate predetermined composite expression data;
said image compositor modifying the predetermined character data based on the predetermined composite expression data to generate the composite character image.

3. The image compositing apparatus in accordance with claim 1 wherein said emotion movement pattern storage stores a viewing point control identification for identifying a viewing point for the composite character image and/or a background image identification for identifying the background of the composite character image, as the emotion movement pattern, in association with the emotion movement pattern;
said movement controller detecting a predetermined viewing point control identification and/or a predetermined background image identification related with the emotion parameter;
said apparatus further comprising:
a viewing point controller for storing a viewing point control parameter controlling an image for displaying a character from a viewing point indicated by the viewing point control identification and for detecting a predetermined viewing point control parameter which is based on the predetermined viewing point control identification; and/or
a background image selector for storing a background image identification indicated by the background image identification for detecting predetermined background image parameter which is based on the predetermined background image identification;
said image compositor generating the composite character image based on the predetermined viewing point control parameter and/or the predetermined background image parameter.

4. The image compositing apparatus in accordance with claim 1 wherein said emotion movement pattern storage stares a fixed-form animation identification for identifying the emotion, as the emotion movement pattern, in association with the emotion parameter;
said movement controller detecting a predetermined fixed-form animation identification related with the predetermined emotion parameter;
said apparatus further comprising:
a fixed-form animation controller for recording expression data in the time domain, expressing the emotion, a viewing point control identification for identifying a viewing point for the composite character image, and/or a background image identification for identifying the background of the composite character image, as animation data, in association with the fixed-form animation identification, and for detecting predetermined expression data related with the fixed-form animation identification, a predetermined viewing point control identification and/or a predetermined background image identification;
a viewing point controller for storing a viewing point control parameter controlling an image for displaying a character from a viewing point indicated by the viewing point control identification and for detecting a predetermined viewing point control parameter which is based on the predetermined viewing point control identification; and/or
a background image selector for storing a background image parameter indicated by the background image identification and for detecting the predetermined background image parameter which is based on the predetermined background image identification;
said image compositor modifying the predetermined character data based on the predetermined expression data and generating the composite character image based on the predetermined viewing point control parameter and/or the predetermined background image parameter.

5. The image compositing apparatus in accordance with claim 1 further comprising an emotion movement pattern setting circuit for rewriting the plural emotion movement patterns, stored in said emotion movement pattern storage, responsive to a command by the user.

6. An image compositing apparatus for generating a composite image based on input information from a user, wherein text data related to text input by the user is input as the input information, said apparatus comprising:
an emotion analyzer for detecting text data, related to text input by the user, as the input information;
an emotion movement pattern storage for storing a plurality of emotion movement patterns related to the emotion parameters;
a movement controller for referencing said emotion movement pattern storage to detect a predetermined emotion movement pattern relating to the predetermined emotion parameter; and
an image compositor for modifying predetermined character data based on the predetermined emotion movement parameter to generate a composite character image.

7. The image compositing apparatus in accordance with claim 6 further comprising a voice input device for inputting voice data corresponding to utterance by the user as the input information.

8. The image compositing apparatus in accordance with claim 6 wherein said emotion movement pattern storage stores the basic emotion identification, for identifying the basic emotion, such as delight, anger, sorrow and pleasure, as the emotion movement pattern, in association with the emotion parameter;
said movement controller detecting a predetermined basic emotion identification related to the predetermined emotion parameter;
said apparatus further comprising:
an image input device for inputting image data, including a face image of the user, as the input information;
an expression feature extracting circuit for extracting predetermined expression data, representing the expressions of the face image of the user, based on the voice data and/or the image data, the predetermined expression data being feature point data representing feature quantities of feature points of a face image;
a basic emotion generator for storing basic emotion data representing the emotion indicated by the basic emotion identification, and for detecting predetermined basic emotion data which is based upon the predetermined basic emotion identification, the basic emotion data being the feature point data; and
an expression compositor for compositing the predetermined expression data with the predetermined basic emotion data to generate predetermined composite expression data;
said image compositor modifying the predetermined character data based on the predetermined composite expression data to generate the composite character image.

9. The image compositing apparatus in accordance with claim 6 wherein said emotion movement pattern storage stores a viewing point control identification for identifying a viewing point for the composite character image and/or a background image identification for identifying the background of the composite character image, as the emotion movement pattern, in association with the emotion movement pattern;
said movement controller detecting a predetermined viewing point control identification and/or a predetermined background image identification related with the emotion parameter;
said apparatus further comprising:
a viewing point controller for recordining a viewing point control parameter controlling an image for displaying a character from a viewing point indicated by the viewing point control identification and for detecting a predetermined viewing point control parameter which is based on the predetermined viewing point control identification; and/or
a background image selector for storing a background image identification indicated by the background image identification for detecting predetermined background image parameter which is based on the predetermined background image identification;
said image compositor generating the composite character image based on the predetermined viewing point control parameter and/or the predetermined background image parameter.

10. The image compositing apparatus in accordance with claim 6 wherein said emotion movement pattern storage stores a fixed-form animation identification for identifying the emotion, as the emotion movement pattern, in association with the emotion parameter;
said movement controller detects a predetermined fixed-form animation identification related with the predetermined emotion parameter;
said apparatus further comprising:
a fixed-form animation controller for recording expression data in the time domain, expressing the emotion, a viewing point control identification for identifying a viewing point for the composite character image, and/or a background image identification for identifying the background of the composite character image, as animation data, in association with the fixed-form animation identification, and for detecting predetermined expression data related with the fixed-form animation identification, a predetermined viewing point control identification and/or a predetermined background image identification;
a viewing point controller for storing a viewing point control parameter controlling an image for displaying a character from a viewing point indicated by the viewing point control identification and for detecting a predetermined viewing point control parameter which is based on the predetermined viewing point control identification; and/or
a background image selector for storing a background image parameter indicated by the background image identification and for detecting the predetermined background image parameter which is based on the predetermined background image identification;
said image compositor modifying the predetermined character data based on the predetermined expression data and generating the composite character image based on the predetermined viewing point control parameter and/or the predetermined background image parameter.

11. The image compositing apparatus in accordance with claim 6 further comprising an emotion movement pattern setting circuit for rewriting the plural emotion movement patterns, stored in said emotion movement pattern storage, responsive to a command by the user.

12. A communication terminal for transmitting or receiving a voice signal and an image signal over a communication network, such as IP (Internet Protocol) network, for communications, said communication terminal comprising:
a communication circuit connected over the IP network, to another communication terminal, as a counterpart of communication, for transmitting or receiving the voice signal and the image signal;
a voice input device for inputting voice data, corresponding to utterances by the user, as the input information;
an emotion analyzer for detecting a predetermined emotion parameter based on processed voice data which is the voice data processed with signal processing;
an emotion movement pattern storage for storing a plurality of emotion movement patterns related with a plurality of emotion parameters;
a movement controller for referencing emotion movement pattern storage to detect a predetermined emotion movement pattern, related with the predetermined emotion parameter; and
an image compositor for modifying predetermined character data, based on the predetermined emotion parameter, to generate a composite character image;
the composite character image and the voice data being encoded to generate the voice signal and the image signal for transmission, the voice signal and the image signal, received by said communication circuit, being decoded to generate received voice data and received image data, the received voice data and received image data being provided to the user.

13. The communication terminal in accordance with claim 12 wherein said emotion movement pattern storage stores the basic emotion identification, for identifying the basic emotion, such as delight, anger, sorrow and pleasure, as the emotion movement pattern, in association with the emotion parameter;
said movement controller detecting a predetermined basic emotion identification related to the predetermined emotion parameter;
said communication terminal further comprising:
an image input device for inputting mage data, including a face image of the user, as the input information;
an expression feature extracting circuit for extracting predetermined expression data, representing the expressions of the face image of the user, based on the voice data and/or the image data, the predetermined expression data being feature point data representing feature quantities of feature points of a face image;
a basic emotion generator for storing basic emotion data representing the emotion indicated by the basic emotion identification, and for detecting predetermined basic emotion data which is based upon the predetermined basic emotion identification, the basic emotion data being the feature point data; and
an expression compositor for compositing the predetermined expression data and the predetermined basic emotion data to generate predetermined composite expression data;
said image compositor modifying the predetermined character data based on the predetermined composite expression data to generate the composite character image.

14. The communication terminal in accordance with claim 12 wherein said emotion movement pattern storage stores a viewing point control identification for identifying a viewing point for the composite character image and/or a background image identification for identifying the background of the composite character image, as the emotion movement pattern, in association with the emotion movement pattern;
said movement controller detecting a predetermined viewing point control identification and/or a predetermined background image identification related with the emotion parameter;
said communication terminal further comprising:
a viewing point controller for storing a viewing point control parameter controlling an image for displaying a character from a viewing point indicated by the viewing point control identification and for detecting a predetermined viewing point control parameter which is based on the predetermined viewing point control identification; and/or
a background image selector for storing a background image parameter represented by the background image identification and for detecting a predetermined background image parameter which is based on the predetermined background image identification;
said image compositor generating the composite character image based on the predetermined viewing point control parameter and/or the predetermined background image parameter.

15. The communication terminal in accordance with claim 12 wherein said emotion movement pattern storage stores a fixed-form animation identification for identifying the emotion, as the emotion movement pattern, in association with the emotion parameter;
said movement controller detecting a predetermined fixed-form animation identification related with the predetermined emotion parameter;
said communication terminal further comprising:
a fixed-form animation controller for recording expression data in the time domain, expressing the emotion, a viewing point control identification for identifying a viewing point for the composite character image, and/or a background image identification for identifying the background of the composite character image, as animation data, in association with the fixed-form animation identification, and for detecting predetermined expression data related with the fixed-form animation identification, a predetermined viewing point control identification and/or a predetermined background image identification; and
a viewing point controller for storing a viewing point control parameter controlling an image for displaying a character from a viewing point indicated by the viewing point control identification and for detecting a predetermined viewing point control parameter which is based on the predetermined viewing point control identification; and/or
a background image selector for storing a background image parameter indicated by the background image identification and for detecting a predetermined background image parameter which is based on the predetermined background image identification;
said image compositor modifying the predetermined character data based on the predetermined expression data and generating the composite character image based on the predetermined viewing point control parameter and/or the predetermined background image parameter.

16. The communication terminal in accordance with claim 12, further comprising an emotion movement pattern setting circuit for rewriting the plural emotion movement patterns, stored in said emotion movement pattern storage, responsive to a command from the user.

17. A communication terminal for transmitting or receiving a voice signal and an image signal over a communication network, such as IP (Internet Protocol) network, for communications, said communication terminal comprising:
a communication circuit connected over the IP network to another communication terminal, as a counterpart of communication, for transmitting or receiving a voice signal and an image signal;
an input device for inputting text data, corresponding to the text input by the user, as the input information;
an emotion analyzer for detecting a predetermined emotion parameter based on the text data;
an emotion movement pattern storage for storing a plurality of emotion movement patterns related to the emotion parameters;
a movement controller for referencing said emotion movement pattern storage to detect a predetermined emotion movement pattern, related with the predetermined emotion parameter; and
an image compositor for modifying predetermined character data based on the predetermined emotion movement pattern to generate a composite character image;
the composite character image and the voice data being encoded to generate the voice signal and the image signal for transmission, the voice signal and the image signal, received by said communication circuit, being decoded to generate received voice data and received image data, the received voice data and received image data being provided to the user.

18. The communication terminal in accordance with claim 17 further comprising: a voice input device for inputting voice data related to the utterance by the user as the input information.

19. The communication terminal in accordance with claim 18 wherein said emotion movement pattern storage stores the basic emotion identification, for identifying the basic emotion, such as delight, anger, sorrow and pleasure, as the emotion movement pattern, in association with said emotion parameter;
said movement controller detecting a predetermined basic emotion identification related to the predetermined emotion parameter;
said communication terminal further comprising:
an image input device for inputting mage data, including a face image of the user, as the input information;
an expression feature extracting circuit for extracting predetermined expression data, representing the expressions of the face image of the user, based on the voice data and/or the image data, the predetermined expression data being feature point data representing feature quantities of feature points of a face image;
a basic emotion generator for storing basic emotion data representing the emotion indicated by the basic emotion identification, and for detecting predetermined basic emotion data which is based upon the predetermined basic emotion identification, the basic emotion data being the feature point data; and
an expression compositor for compositing the predetermined expression data and the predetermined basic emotion data to generate predetermined composite expression data;
said image compositor modifying the predetermined character data based on the predetermined composite expression data to generate the composite character image.

20. The communication terminal in accordance with claim 18 wherein said emotion movement pattern storage stores a viewing point control identification for identifying a viewing point for the composite character image and/or a background image identification for identifying the background of the composite character image, as the emotion movement pattern, in association with the emotion movement pattern;
said movement controller detecting a predetermined viewing point control identification and/or a predetermined background image identification related with the emotion parameter;
said communication terminal further comprising:
a viewing point controller for storing a viewing point control parameter controlling an image for displaying a character from a viewing point indicated by the viewing point control identification and for detecting a predetermined viewing point control parameter which is based on the predetermined viewing point control identification; and/or
a background image selector for storing a background image parameter represented by the background image identification and for detecting a predetermined background image parameter which is based on the predetermined background image identification;
said image compositor generating the composite character image based on the predetermined viewing point control parameter and/or the predetermined background image parameter.

21. The communication terminal in accordance with claim 17 wherein said emotion movement pattern storage stores a fixed-form animation identification for identifying the emotion, as the emotion movement pattern, in association with the emotion parameter;
said movement controller detecting a predetermined fixed-form animation identification related with the predetermined emotion parameter;
said communication terminal further comprising:
a fixed-form animation controller for recording expression data in the time domain, expressing the emotion, a viewing point control identification for identifying a viewing point for the composite character image, and/or a background image identification for identifying the background of the composite character image, as animation data, in association with the fixed-form animation identification, and for detecting predetermined expression data related with the fixed-form animation identification, a predetermined viewing point control identification and/or a predetermined background image identification; and
a viewing point controller for storing a viewing point control parameter controlling an image for displaying a character from a viewing point indicated by the viewing point control identification and for detecting a predetermined viewing point control parameter which is based on the predetermined viewing point control identification; and/or
a background image selector for storing a background image parameter indicated by the background image identification and for detecting a predetermined background image parameter which is based on the predetermined background image identification;
said image compositor modifying the predetermined character data based on the predetermined expression data and generating the composite character image based on the predetermined viewing point control parameter and/or the predetermined background image parameter.

22. The communication terminal in accordance with claim 17, further comprising an emotion movement pattern setting circuit for rewriting the plural emotion movement patterns, stored in said emotion movement pattern storage, responsive to a command from the user.

23. The communication terminal in accordance with claim 17, further comprising:
a text chat client circuit having a chat function for setting up a chat session with a chat server via said communication circuit and the IP network and for transmitting or receiving text data to or from said chat server; and
a filter for sending transmission text data from said text input device to said text chat client circuit, when the user inputs the transmission text data, which is to be transmitted to said chat server, to said text input device, for extracting text data indicating a message part out of the transmission text data to send the so extracted text data to said image compositor.

24. A communication terminal for transmitting or receiving a voice signal and an image signal over a communication network, such as IP (Internet Protocol) network, for communications, said communication terminal comprising:
a communication circuit connected over the IP network to another communication terminal, as a counterpart of communication, for transmitting or receiving the voice signal and then image signal;
a voice input device for inputting voice data, corresponding to utterance by the user, as the input information;
an emotion analyzer for detecting a predetermined emotion parameter based on processed voice data obtained on processing the voice data;
an emotion movement pattern storage for storing a plurality of emotion movement patterns related to the emotion parameters;
a movement controller for referencing said emotion movement pattern storage to detect a predetermined emotion movement pattern, related with the predetermined emotion parameter; and
a control packet generator for packetizing a control parameter for modifying predetermined character data, detected based on the predetermined emotion movement pattern, to generate a control packet;
said communication circuit transmitting or receiving the control packet as the image signal;
said communication terminal further comprising an image compositor for modifying predetermined character data, based on the control parameter extracted from the control packet received by said communication circuit to generate a composite character image;
the voice data being encoded to generate the voice signal and the image signal for transmission, the voice signal received by said communication circuit being decoded to generate received voice data, the received voice data and the composite character image being provided to the user.

25. The communication terminal in accordance with claim 24 wherein said emotion movement pattern storage stores the basic emotion identification, for identifying the basic emotion, such as delight, anger, sorrow and pleasure, as the emotion movement pattern, in association with the emotion parameter;
said movement controller detecting a predetermined basic emotion identification related to the predetermined emotion parameter;
said communication terminal further comprising:
an image input device for inputting mage data, including a face image of the user, as the input information;
an expression feature extracting circuit for extracting predetermined expression data, representing the expressions of the face image of the user, based on the image data, the predetermined expression data being feature point data representing feature quantities of feature points of a face image;
a basic emotion generator for storing basic emotion data representing the emotion indicated by the basic emotion identification, and for detecting predetermined basic emotion data which is based upon the predetermined basic emotion identification, the basic emotion data being the feature point data;
an expression compositor for compositing the predetermined expression data and the predetermined basic emotion data to generate predetermined composite expression data; and
an expression packet generator for packetizing the predetermined composite expression data to generate an expression packet;
the control packet and the expression packet being integrated together to generate predetermined packet data;
said communication circuit transmitting or receiving the predetermined packet data as the image signal;
said image compositor modifying the predetermined character data based on the control parameter and the expression data extracted from the packet data received by said communication circuit and on the expression data.

26. The communication terminal in accordance with claim 24 wherein said emotion movement pattern storage stores the viewing point control identification for identifying a viewing point for the composite character image and/or the background image identification for identifying the background of the composite character image, in association with the emotion parameter;
said movement controller detecting a predetermined viewing point control identification or a predetermined background image identification related with the predetermined emotion parameter;
said communication terminal including a viewing point controller for storing a viewing point control parameter for controlling an image for displaying a character at a viewing point indicated by the viewing point control identification and for detecting a predetermined viewing point control parameter which is based on the predetermined viewing point control identification and/or background image selector for storing a background image parameter indicated by the background image identification and for detecting a predetermined background image parameter which is based on the predetermined background image identification;
said communication terminal further comprising an expression packet generator for packetizing the predetermined expression data for generating an expression packet;
said expression packet generator packetizing the predetermined viewing point parameter and/or the predetermined background image parameter to generate the predetermined control packet;
said communication terminal integrating the expression packet and the control packet together to generate predetermined packet data;
said communication circuit transmitting or receiving the predetermined packet data as the image signal;
said image compositor modifying the predetermined character data based on the expression data extracted from the predetermined packet data received by the communication circuit and on the predetermined viewing point parameter and/or the predetermined background image parameter.

27. The communication terminal in accordance with claim 24 wherein said emotion movement pattern storage stores a fixed-form animation identification for identifying the emotion, as the emotion movement pattern, in association with the emotion parameter;
said movement controller detecting a predetermined fixed-form animation identification related with the predetermined emotion parameter;
said communication terminal further comprising:
a fixed-form animation controller for recording expression data in the time domain, expressing the emotion, a viewing point control identification for identifying a viewing point for the composite character image, and/or a background image identification for identifying the background of the composite character image, as animation data, in association with the fixed-form animation identification, and for detecting predetermined expression data related with the fixed-form animation identification, a predetermined viewing point control identification and/or a predetermined background image identification;
a viewing point controller for storing a viewing point control parameter controlling an image for displaying a character from a viewing point indicated by the viewing point control identification and for detecting a predetermined viewing point control parameter which is based on the predetermined viewing point control identification; and/or
a background image selector for storing a background image identification and for detecting a background image parameter indicated by the detecting predetermined background image parameter which is based on the predetermined background image identification; and
an expression packet generator for packetizing the predetermined expression data to generate an expression packet;
said control packet generator packetizing the predetermined viewing point parameter and/or the predetermined background image parameter to generate the predetermined control packet;
said communication terminal integrating the control packet and the expression packet together to generate predetermined packet data;
said communication circuit transmitting or receiving the predetermined packet data as the image signal;
said image compositor modifying the predetermined character data to generate the composite character image based on the expression data extracted from the predetermined packet data received by said communication circuit and on the predetermined viewing point parameter and/or the predetermined background image parameter.

28. The communication terminal in accordance with claim 24 further comprising an emotion movement pattern setting circuit for rewriting the plural emotion movement patterns, stored in the emotion movement pattern storage, responsive to a command from the user.

29. A communication terminal for transmitting or receiving a voice signal and an image signal over a communication network, such as IP (Internet Protocol) network, for communications, said communication terminal comprising:
a communication circuit connected over the IP network to another communication terminal, as a counterpart of communication, for transmitting or receiving a voice signal and an image signal;
a text input device for inputting text data, related to the text input by the user, as the input information;
an emotion analyzer for detecting a predetermined emotion parameter based on the text data;
an emotion movement pattern storage for storing a plurality of emotion movement patterns related to the emotion parameters;
a movement controller for referencing said emotion movement pattern storage to detect a predetermined emotion movement pattern, related with the predetermined emotion parameter; and
a control packet generator for packetizing a control parameter for modifying predetermined character data, detected based on the predetermined emotion movement pattern, to generate a control packet;
said communication circuit transmitting or receiving the control packet as the image signal;
said communication terminal further comprising an image compositor for modifying predetermined character data, based on a control parameter extracted from the control packet received by said communication circuit to generate a composite character image;
the voice data being encoded to generate the voice signal for transmission, the voice signal received by said communication circuit being decoded to generate received voice data, the received voice data and received composite character data being provided to the user.

30. The communication terminal in accordance with claim 29 further comprising a voice input device for inputting voice data corresponding to utterance by the user as the input information.

31. The communication terminal in accordance with claim 30 wherein said emotion movement pattern storage stores the basic emotion identification, for identifying the basic emotion, such as delight, anger, sorrow and pleasure, as the emotion movement pattern, in association with the emotion parameter;
said movement controller detecting a predetermined basic emotion identification related to the predetermined emotion parameter;
said communication terminal further comprising:
an image input device for inputting mage data, including a face image of the user, as the input information;
an expression feature extracting circuit for extracting predetermined expression data, representing the expressions of the face image of the user, based on the image data, the predetermined expression data being feature point data representing feature quantities of feature points of a face image;
a basic emotion generator for storing basic emotion data representing the emotion indicated by the basic emotion identification, and for detecting predetermined basic emotion data which is based upon the predetermined basic emotion identification, the basic emotion data being the feature point data;
an expression compositor for compositing the predetermined expression data and the predetermined basic emotion data to generate predetermined composite expression data; and
an expression packet generator for packetizing the predetermined composite expression data to generate an expression packet;
the control packet and the expression packet being integrated together to generate predetermined packet data;
said communication circuit transmitting or receiving the predetermined packet data as the image signal;
said image compositor modifying the predetermined character data based on the control parameter and the expression data extracted from the packet data received by said communication circuit and on the expression data.

32. The communication terminal in accordance with claim 30 wherein said emotion movement pattern storage stores the viewing point control identification for identifying a viewing point for the composite character image and/or the background image identification for identifying the background of the composite character image, in association with the emotion parameter;
said movement controller detecting a predetermined viewing point control identification or a predetermined background image identification related with the predetermined emotion parameter;
said communication terminal including a viewing point controller for storing a viewing point control parameter for controlling an image for displaying a character at a viewing point indicated by the viewing point control identification and for detecting a predetermined viewing point control parameter which is based on the predetermined viewing point control identification and/or background image selector for storing a background image parameter indicated by the background image identification and for detecting a predetermined background image parameter which is based on the predetermined background image identification;
said communication terminal further comprising an expression packet generator for packetizing the predetermined expression data for generating an expression packet;
said expression packet generator packetizing the predetermined viewing point parameter and/or the predetermined background image parameter to generate the predetermined control packet;
said communication terminal integrating the expression packet and the control packet together to generate predetermined packet data;
said communication circuit transmitting or receiving the predetermined packet data as the image signal;
said image compositor modifying the predetermined character data based on the expression data extracted from the predetermined packet data received by the communication circuit and on the predetermined viewing point parameter and/or the predetermined background image parameter.

33. The communication terminal in accordance with claim 29 wherein said emotion movement pattern storage stores a fixed-form animation identification for identifying the emotion, as the emotion movement pattern, in association with the emotion parameter;
said movement controller detecting a predetermined fixed-form animation identification related with the predetermined emotion parameter;
said communication terminal further comprising:
a fixed-form animation controller for recording expression data in the time domain, expressing the emotion, a viewing point control identification for identifying a viewing point for the composite character image, and/or a background image identification for identifying the background of the composite character image, as animation data, in association with the fixed-form animation identification, and for detecting predetermined expression data related with the fixed-form animation identification, a predetermined viewing point control identification and/or a predetermined background image identification;
a viewing point controller for storing a viewing point control parameter controlling an image for displaying a character from a viewing point indicated by the viewing point control identification and for detecting a predetermined viewing point control parameter which is based on the predetermined viewing point control identification; and/or
a background image selector for storing a background image identification and for detecting a background image parameter indicated by the detecting predetermined background image parameter which is based on the predetermined background image identification; and
an expression packet generator for packetizing the predetermined expression data to generate an expression packet;
said control packet generator packetizing the predetermined viewing point parameter and/or the predetermined background image parameter to generate the predetermined control packet;
said communication terminal integrating the control packet and the expression packet together to generate predetermined packet data;
said communication circuit transmitting or receiving the predetermined packet data as the image signal;
said image compositor modifying the predetermined character data to generate the composite character image based on the expression data extracted from the predetermined packet data received by the communication circuit and on the predetermined viewing point parameter and/or the predetermined background image parameter.

34. The communication terminal in accordance with claim 29, further comprising an emotion movement pattern setting circuit for rewriting the plural emotion movement patterns, stored in said emotion movement pattern storage, responsive to a command from the user.

35. The communication terminal in accordance with claim 29, further comprising:
a text chat client circuit having a chat function for setting up a chat session with a chat server via said communication circuit and the IP network and for transmitting or receiving text data with said chat server; and
a filter for sending transmission text data from said text input device to said text chat client circuit, when the user inputs the transmission text data, which is to be transmitted to said chat server, to said text input device, for extracting text data indicating a message part out of the transmission text data to send the so extracted text data to said image compositor.

36. An image communication system employing a plurality of communication terminals for transmitting or receiving a voice signal and an image signal over a communication network, such as IP (Internet Protocol) network, for communications, wherein predetermined one of said communication terminals comprises:
a communication circuit connected over the IP network to another communication terminal, as a counterpart of communication, for transmitting or receiving a voice signal and an image signal;
a voice input device for inputting voice data, corresponding to utterance by the user, as the input information;
an emotion analyzer for detecting a predetermined emotion parameter based on processed voice data obtained on processing the voice data with signal processing;
an emotion movement pattern storage for storing a plurality of emotion movement patterns related to the emotion parameters;
a movement controller for referencing said emotion movement pattern storage to detect a predetermined emotion movement pattern, related with the predetermined emotion parameter; and
an image compositor for modifying predetermined character data, based on the predetermined emotion movement pattern, to generate a composite character image;
said composite character image and the voice data being encoded to generate the voice signal and the image signal for transmission, the voice signal and the image signal, received by said communication circuit, being decoded to generate received voice data and received image data, the received voice data and received image data being provided to the user.

37. The image communication system in accordance with claim 36 wherein said emotion movement pattern storage stores the basic emotion identification, for identifying the basic emotion, such as delight, anger, sorrow and pleasure, as the emotion movement pattern, in association with the emotion parameter;
said movement controller detecting a predetermined basic emotion identification related to the predetermined emotion parameter;
said predetermined communication terminal further comprising:
an image input device for inputting mage data, including a face image of the user, as the input information;
an expression feature extracting circuit for extracting predetermined expression data, representing the expressions of the face image of the user, based on the voice data and/or the image data, the predetermined expression data being feature point data representing feature quantities of feature points of a face image;
a basic emotion generator for storing basic emotion data representing the emotion indicated by the basic emotion identification, and for detecting predetermined basic emotion data which is based upon the predetermined basic emotion identification, the basic emotion data being the feature point data; and
an expression compositor for compositing the predetermined expression data and the predetermined basic emotion data to generate predetermined composite expression data; and
said image compositor modifying the predetermined character data based on the predetermined composite expression data to generate the composite character image.

38. An image communication system in accordance with claim 36 wherein said emotion movement pattern storage stores the viewing point control identification for identifying a viewing point for the composite character image and/or the background image identification for identifying the background of the composite character image, as the emotion movement pattern, in association with the emotion parameter;
said movement controller detecting a predetermined viewing point control identification or a predetermined background image identification related with the predetermined emotion parameter;
said communication terminal further comprising:
a viewing point controller for storing a viewing point control parameter controlling an image to display a character from a viewing point indicated by the viewing point control identification, and for detecting a predetermined viewing point control parameter which is based on the predetermined viewing point control identification; and/or
a background image selector for storing a background image parameter indicated by the background image identification and for detecting a predetermined background image parameter which is based on the predetermined background image identification;
said image compositor generating the composite character image based on the predetermined viewing point parameter and/or the predetermined background image parameter.

39. The image communication system in accordance with claim 36 wherein said emotion movement pattern storage stores a fixed-form animation identification, identifying the emotion, as the emotion movement pattern, in association with the emotion parameter;
said movement controller detecting a predetermined fixed-form animation identification related with the predetermined emotion parameter;
said predetermined communication terminal further comprising:
a fixed-form animation controller for recording expression data in the time domain, expressing the emotion, a viewing point control identification for identifying a viewing point for the composite character image, and/or a background image identification for identifying the background of the composite character image, as animation data, in association with the fixed-form animation identification, and for detecting predetermined expression data related with the fixed-form animation identification, a predetermined viewing point control identification and/or a predetermined background image identification; and
a viewing point controller for storing a viewing point control parameter controlling an image to display a character from a viewing point indicated by the viewing point control identification and for detecting a predetermined viewing point control parameter which is based on the predetermined viewing point control identification; and/or
a background image selector for storing a background image parameter indicated by the background image identification and for detecting a predetermined background image parameter which is based on the predetermined background image identification;
said image compositor modifying the predetermined character data based on the predetermined expression data and for generating the composite character image based on the predetermined viewing point parameter and/or the predetermined background image parameter.

40. The image communication system in accordance with claim 36, wherein said predetermined communication terminal further comprises an emotion movement pattern setting circuit for rewriting the plural emotion movement patterns, stored in the emotion movement pattern storage, responsive to a command from the user.

41. An image communication system employing a plurality of communication terminals for transmitting or receiving a voice signal and an image signal over a communication network, such as IP (Internet Protocol) network, for communications, wherein predetermined one of said communication terminals comprises:
a communication circuit connected over the IP network, to another communication terminal as a counterpart of communication, for transmitting or receiving a voice signal and an image signal;
a voice input device for inputting voice data, related to utterance by the user, as the input information;
an emotion analyzer for detecting a predetermined emotion parameter based on the processed voice data which is the voice data processed with signal processing;
an emotion movement pattern storage for storing a plurality of emotion movement patterns related to the emotion parameters;
a movement controller for referencing said emotion movement pattern storage to detect a predetermined emotion movement pattern, related with the predetermined emotion parameter; and
an image compositor for modifying predetermined character data, based on the predetermined emotion movement pattern, to generate a composite character image;
said composite character image and the voice data being encoded to generate the voice signal and the image signal for transmission, the voice signal and the image signal, received by said communication circuit, being decoded to generate received voice data and received image data, the received voice data and received image data being provided to the user.

42. The image communication system in accordance with claim 41 wherein said predetermined communication terminal further comprises a voice input device for inputting voice data corresponding to the by the user as the input information.

43. The image communication system in accordance with claim 42 wherein said emotion movement pattern storage stores the basic emotion identification, for identifying the basic emotion, such as delight, anger, sorrow and pleasure, as the emotion movement pattern, in association with the emotion parameter;
said movement controller detecting a predetermined basic emotion identification related to the predetermined emotion parameter;
said predetermined communication terminal further comprising:
an image input device for inputting mage data, including a face image of the user, as the input information;
an expression feature extracting circuit for extracting predetermined expression data, representing the expressions of the face image of the user, based on the voice data and/or the image data, the predetermined expression data being feature point data representing feature quantities of feature points of a face image;
a basic emotion generator for storing basic emotion data representing the emotion indicated by the basic emotion identification, and for detecting predetermined basic emotion data which is based upon the predetermined basic emotion identification, the basic emotion data being the feature point data; and
an expression compositor for compositing the predetermined expression data and the predetermined basic emotion data to generate predetermined composite expression data; and
said image compositor modifying the predetermined character data based on the predetermined composite expression data to generate the composite character image.

44. An image communication system in accordance with claim 42 wherein said emotion movement pattern storage stores the viewing point control identification for identifying a viewing point for the composite character image and/or the background image identification for identifying the background of the composite character image, as the emotion movement pattern, in association with the emotion parameter;
said movement controller detecting a predetermined viewing point control identification or a predetermined background image identification related with the predetermined emotion parameter;
said communication terminal further comprising:
a viewing point controller for storing a viewing point control parameter controlling an image to display a character from a viewing point indicated by the viewing point control identification, and for detecting a predetermined viewing point control parameter which is based on the predetermined viewing point control identification; and/or
a background image selector for storing a background image parameter indicated by the background image identification and for detecting a predetermined background image parameter which is based on the predetermined background image identification;
said image compositor generating the composite character image based on the predetermined viewing point parameter and/or the predetermined background image parameter.

45. The image communication system in accordance with claim 41 wherein said emotion movement pattern storage stores a fixed-form animation identification, identifying the emotion, as the emotion movement pattern, in association with the emotion parameter;
said movement controller detecting a predetermined fixed-form animation identification related with the predetermined emotion parameter;
said predetermined communication terminal further comprising:
a fixed-form animation controller for recording expression data in the time domain, expressing the emotion, a viewing point control identification for identifying a viewing point for the composite character image, and/or a background image identification for identifying the background of the composite character image, as animation data, in association with the fixed-form animation identification, and for detecting predetermined expression data related with the fixed-form animation identification, a predetermined viewing point control identification and/or a predetermined background image identification; and
a viewing point controller for storing a viewing point control parameter controlling an image to display a character from a viewing point indicated by the viewing point control identification and for detecting a predetermined viewing point control parameter which is based on the predetermined viewing point control identification; and/or
a background image selector for storing a background image parameter indicated by the background image identification and for detecting a predetermined background image parameter which is based on the predetermined background image identification;
said image compositor modifying the predetermined character data based on the predetermined expression data and for generating the composite character image based on the predetermined viewing point parameter and/or the predetermined background image parameter.

46. The image communication system in accordance with claim 41, wherein said predetermined communication terminal further comprises an emotion movement pattern setting circuit for rewriting the plural emotion movement patterns, stored in the emotion movement pattern storage, responsive to a command from the user.

47. The image communication system in accordance with claim 43, comprising a character management center including a plurality of character data; wherein
said predetermined communication terminal further includes:
an emotion movement pattern setting circuit for rewriting the emotion movement patterns stored in the emotion movement pattern storage responsive to a command from the user; and
a character manager for instructing the character management center to download character data responsive to a command by the user to hold new character data downloaded from the character management center;
said image compositor holding a parameter concerning the predetermined character data;
said character manager being responsive to downloading of the new character data sending to said basic emotion generator a basic emotion parameter for updating the basic emotion identification and the basic emotion data stored in the basic emotion generator to a basic emotion identification and basic emotion data relating to the new character data, sending to said emotion movement pattern setting circuit an emotion movement pattern designating signal for storing an emotion movement pattern relating to the new character data in said emotion movement pattern storage, and sending to said image compositor a character data parameter updating a parameter concerning the predetermined character data to a parameter concerning the new character data.

48. The image communication system in accordance with claim 44, comprising a character management center including a plurality of character data; wherein
said predetermined communication terminal further includes:
an emotion movement pattern setting circuit for rewriting the emotion movement patterns stored in said emotion movement pattern storage, responsive to a command from the user; and
a character manager responsive to a command from the user instructing the character management center to download character data to hold new character data downloaded from the character management center;
said image compositor holding a parameter concerning the predetermined character data;
said character manager being responsive to downloading of the new character data parameter sending to said viewing point controller and said background image selector a control parameter for updating the viewing point control identification and the viewing point control parameter and/or a background image identification and a background image parameter, stored in said viewing point controller and/or in said background image selector, to a viewing point control identification and a viewing point control parameter and/or a background image identification and a background image parameter matched to the new character data, sending to said emotion movement pattern setting circuit an emotion movement pattern designating signal for storing an emotional movement pattern relating to the new character data in said emotion movement pattern storage, and sending to said image compositor a character data parameter updating a parameter concerning the predetermined character data to a parameter concerning the new character data.

49. The image communication system in accordance with claim 45, comprising a character management center including a plurality of character data; wherein
said predetermined communication terminal further includes:
an emotion movement pattern setting circuit for rewriting the emotion movement patterns stored in said emotion movement pattern storage, responsive to a command from the user; and
a character manager responsive to a command from the user instructing the character management center to download character data to hold new character data downloaded from the character management center;
said image compositor holding a parameter concerning the predetermined character data;
said character manager being responsive to downloading of the new character data parameter sending to said viewing point controller and said background image selector a control parameter for updating the viewing point control identification and the viewing point control parameter and/or a background image identification and a background image parameter, stored in said viewing point controller and/or in said background image selector, to a viewing point control identification and a viewing point control parameter and/or a background image identification and a background image parameter matched to the new character data, sending to said emotion movement pattern setting circuit an emotion movement pattern designating signal for storing an emotional movement pattern relating to the new character data in said emotion movement pattern storage, and sending to said image compositor a character data parameter updating a parameter concerning the predetermined character data to a parameter concerning the new character data.

50. The image communication system in accordance with claim 41, further comprising:
a chat server for setting up a chat session with said communication terminal
said predetermined communication terminal further comprising:
a text chat client circuit having a chat function for setting up a chat session with said chat server via said communication circuit and the IP network and for transmitting or receiving text data to or from said chat server; and
a filter for sending transmission text data from text input device to said text chat client circuit, when the user inputs the transmission text data for transmission to said chat server to said text input device, for extracting text data indicating a message part out of the transmission text data to send the so extracted text data to said image compositor.

51. An image communication system for transmitting or receiving a voice signal and an image signal over a communication network, such as IP (Internet Protocol) network, for communications, wherein predetermined one of said communication terminals comprises:
a communication circuit connected over the IP network to another communication terminal, as a counterpart of communication, for transmitting or receiving a voice signal and an image signal;
a voice input device for inputting voice data, corresponding to utterance by the user, as the input information;
an emotion analyzer for detecting a predetermined emotion parameter based on processed voice data which is the voice data processed with signal processing;
an emotion movement pattern storage for storing a plurality of emotion movement patterns related to the emotion parameters;
a movement controller for referencing said emotion movement pattern storage to detect a predetermined emotion movement pattern, related with the predetermined emotion parameter; and
a control packet generator for packetizing a control parameter modifying predetermined character data, detected based on the predetermined emotion movement pattern, to generate a control packet;
said communication circuit transmitting or receiving the control packet as the image signal;
said predetermined communication terminal further comprising an image compositor for modifying predetermined character data, based on a control parameter extracted from the control packet received by said communication circuit to generate a composite character image;
the voice data being encoded to generate the voice signal for transmission; the voice signal, received by said communication circuit, being decoded to generate received voice data, the received voice data and the composite character image data being provided to the user.

52. The image communication system in accordance with claim 51 wherein said emotion movement pattern storage stores the basic emotion identification, for identifying the basic emotion, such as delight, anger, sorrow and pleasure, as the emotion movement pattern, in association with the emotion parameter;
said movement controller detecting a predetermined basic emotion identification related to the predetermined emotion parameter;
said predetermined communication terminal further comprising:
an image input device for inputting mage data, including a face image of the user, as the input information;
an expression feature extracting circuit for extracting predetermined expression data, representing the expressions of the face image of the user, based on the voice data and/or the image data, the predetermined expression data being feature point data representing feature quantities of feature points of a face image;
a basic emotion generator for storing basic emotion data representing the emotion indicated by the basic emotion identification, and for detecting predetermined basic emotion data which is based upon the predetermined basic emotion identification, the basic emotion data being the feature point data;
an expression compositor for compositing the predetermined expression data and the predetermined basic emotion data to generate predetermined composite expression data; and
an expression packet generator for packetizing the predetermined composite expression data to generate an expression packet;
the control packet and the expression packet being integrated together to generate predetermined packet data;
said communication circuit transmitting or receiving the predetermined packet data as the image signal;
said image compositor modifying the predetermined character data based on the control parameter and the expression data extracted from the packet data received by the communication circuit to generate the composite character image.

53. The image communication system in accordance with claim 51 wherein said emotion movement pattern storage stores a viewing point control identification for identifying a viewing point for the composite character image and/or a background image identification for identifying the background of the composite character image, in association with the emotion parameter;
said movement controller detecting a predetermined viewing point control identification or a predetermined background image identification related with the predetermined emotion parameter;
said predetermined communication terminal further comprising:
a viewing point controller for storing a viewing point control parameter controlling an image to display a character from a viewing point indicated by the viewing point control identification and for detecting a predetermined viewing point control parameter which is based on the predetermined viewing point control identification; and/or
a background image selector for storing a background image parameter indicated by the background image identification and for detecting a predetermined background image parameter which is based on the predetermined background image identification;
said predetermined communication terminal further including an expression packet generator for packetizing the predetermined expression data for generating an expression packet;
said expression packet generator packetizing the predetermined viewing point parameter and/or the predetermined background image parameter to generate the predetermined control packet;
said predetermined communication terminal integrating the expression packet and the control packet together to generate predetermined packet data;
said communication circuit transmitting or receiving the predetermined packet data as the image signal;
said image compositor modifying the predetermined character data, based on the expression data extracted from the predetermined packet data received by said communication circuit and on the predetermined viewing point parameter and/or the predetermined background image parameter, to generate the composite character image.

54. The image communication system in accordance with claim 51 wherein said emotion movement pattern storage stores a fixed-form animation identification for identifying the emotion, as the emotion movement pattern, in association with the emotion parameter;
said movement controller detecting a predetermined fixed-form animation identification related with the predetermined emotion parameter;
said predetermined communication terminal further comprising:
a fixed-form animation controller for recording expression data in the time domain, expressing the emotion, a viewing point control identification for identifying a viewing point for the composite character image, and/or a background image identification for identifying the background of the composite character image, as animation data, in association with the fixed-form animation identification, and for detecting predetermined expression data related with the fixed-form animation identification, a predetermined viewing point control identification and/or a predetermined background image identification;
a viewing point controller for storing a viewing point control parameter controlling an image to display a character from a viewing point indicated by the viewing point control identification and for detecting a predetermined viewing point control parameter which is based on the predetermined viewing point control identification; and/or
a background image selector for storing a background image parameter indicated by the background image identification for detecting a predetermined background image parameter which is based on the predetermined background image identification; and
an expression packet generator for packetizing the predetermined expression data to generate an expression packet;
said control packet generator packetizing the predetermined viewing point parameter and/or the predetermined background image parameter to generate the predetermined control packet;
said predetermined communication terminal integrating the control packet and the expression packet together to generate predetermined packet data;
said communication circuit transmitting or receiving the predetermined packet data as the image signal;
said image compositor modifying the predetermined character data based on the expression data extracted from the predetermined packet data received by said communication circuit and on the predetermined viewing point parameter and/or the predetermined background image parameter to generate the composite character image.

55. The image communication system in accordance with claim 51, wherein said predetermined communication terminal further comprises an emotion movement pattern setting circuit for rewriting the plural emotion movement patterns, stored in the emotion movement pattern storage, responsive to a command from the user.

56. An image communication system employing a plurality of communication terminals for transmitting or receiving a voice signal and an image signal over a communication network, such as IP (Internet Protocol) network, for communications, wherein predetermined one of said communication terminals comprises:
a communication circuit connected over the IP network to another communication terminal, as a counterpart of communication, for transmitting or receiving a voice signal and an image signal;
a text input device for inputting text data, related to the text input by the user, as the input information;
an emotion analyzer for detecting a predetermined emotion parameter based on the text data;
an emotion movement pattern storage for storing a plurality of emotion movement patterns related to the emotion parameters;
a movement controller for referencing said emotion movement pattern storage to detect a predetermined emotion movement pattern, related with the predetermined emotion parameter; and
a control packet generator for packetizing a control parameter modifying predetermined character data, detected based on the predetermined emotion movement pattern, to generate a control packet;
said communication circuit transmitting or receiving the control packet as the image signal;
said predetermined communication terminal further comprising an image compositor for modifying predetermined character data, based on a control parameter extracted from the control packet received by said communication circuit to generate a composite character image;
the voice data being encoded to generate the voice signal for transmission and the voice signal received by said communication circuit being decoded to generate received voice data, the received voice data and composite character image data being provided to the user.

57. The image communication system in accordance with claim 56 wherein said predetermined communication terminal further comprises a voice input device for inputting voice data corresponding to utterance by the user as the input information.

58. The image communication system in accordance with claim 57 wherein said emotion movement pattern storage stores the basic emotion identification, for identifying the basic emotion, such as delight, anger, sorrow and pleasure, as the emotion movement pattern, in association with the emotion parameter;
said movement controller detecting a predetermined basic emotion identification related to the predetermined emotion parameter;
said predetermined communication terminal further comprising:
an image input device for inputting mage data, including a face image of the user, as the input information;
an expression feature extracting circuit for extracting predetermined expression data, representing the expressions of the face image of the user, based on the voice data and/or the image data, the predetermined expression data being feature point data representing feature quantities of feature points of a face image;
a basic emotion generator for storing basic emotion data representing the emotion indicated by the basic emotion identification, and for detecting predetermined basic emotion data which is based upon the predetermined basic emotion identification, the basic emotion data being the feature point data;
an expression compositor for compositing the predetermined expression data and the predetermined basic emotion data to generate predetermined composite expression data; and
an expression packet generator for packetizing the predetermined composite expression data to generate an expression packet;
said control packet and the expression packet being integrated together to generate predetermined packet data;
said communication circuit transmitting or receiving the predetermined packet data as the image signal;
said image compositor modifying the predetermined character data based on the control parameter and the expression data extracted from the packet data received by the communication circuit to generate the composite character image.

59. The image communication system in accordance with claim 57 wherein said emotion movement pattern storage stores a viewing point control identification for identifying a viewing point for the composite character image and/or a background image identification for identifying the background of the composite character image, in association with the emotion parameter;
said movement controller detecting a predetermined viewing point control identification or a predetermined background image identification related with the predetermined emotion parameter;
said predetermined communication terminal further comprising:
a viewing point controller for storing a viewing point control parameter controlling an image to display a character from a viewing point indicated by the viewing point control identification and for detecting a predetermined viewing point control parameter which is based on the predetermined viewing point control identification; and/or
a background image selector for storing a background image parameter indicated by the background image identification and for detecting a predetermined background image parameter which is based on the predetermined background image identification;
said predetermined communication terminal further including an expression packet generator for packetizing the predetermined expression data for generating an expression packet;
said expression packet generator packetizing the predetermined viewing point parameter and/or the predetermined background image parameter to generate the predetermined control packet;
said predetermined communication terminal integrating the expression packet and the control packet together to generate predetermined packet data;
said communication circuit transmitting or receiving the predetermined packet data as the image signal;
said image compositor modifying the predetermined character data, based on the expression data extracted from the predetermined packet data received by the communication circuit and on the predetermined viewing point parameter and/or the predetermined background image parameter, to generate the composite character image.

60. The image communication system in accordance with claim 56 wherein said emotion movement pattern storage stores a fixed-form animation identification for identifying the emotion, as the emotion movement pattern, in association with the emotion parameter;
said movement controller detecting a predetermined fixed-form animation identification related with the predetermined emotion parameter;
said predetermined communication terminal further comprising:
a fixed-form animation controller for recording expression data in the time domain, expressing the emotion, a viewing point control identification for identifying a viewing point for the composite character image, and/or a background image identification for identifying the background of the composite character image, as animation data, in association with the fixed-form animation identification, and for detecting predetermined expression data related with the fixed-form animation identification, a predetermined viewing point control identification and/or a predetermined background image identification;
a viewing point controller for storing a viewing point control parameter controlling an image to display a character from a viewing point indicated by the viewing point control identification and for detecting a predetermined viewing point control parameter which is based on the predetermined viewing point control identification; and/or
a background image selector for storing a background image parameter indicated by the background image identification for detecting a predetermined background image parameter which is based on the predetermined background image identification; and
an expression packet generator for packetizing the predetermined expression data to generate an expression packet;
said control packet generator packetizing the predetermined viewing point parameter and/or the predetermined background image parameter to generate the predetermined control packet;
said predetermined communication terminal integrating the control packet and the expression packet together to generate predetermined packet data;
said communication circuit transmitting or receiving the predetermined packet data as the image signal;
said image compositor modifying the predetermined character data based on the expression data extracted from the predetermined packet data received by the communication circuit and on the predetermined viewing point parameter and/or the predetermined background image parameter to generate the composite character image.

61. The image communication system in accordance with claim 56, wherein said predetermined communication terminal further comprises an emotion movement pattern setting circuit for rewriting the plural emotion movement patterns, stored in said emotion movement pattern storage, responsive to a command from the user.

62. The image communication system in accordance with claim 57, further comprising a character management center including a plurality of character data; wherein
said predetermined communication terminal further comprising a character manager for instructing the character management center to download character data responsive to a command by the user to hold new character data downloaded from the character management center;
said image compositor holding a parameter relating to the predetermined character data;
said character manager sending to said emotion movement pattern setting circuit an emotion movement pattern designating signal instructing recording an emotion movement pattern related to the new character data in said emotion movement pattern storage, and sending to said image compositor a control signal instructing updating a parameter concerning the predetermined character data to a parameter concerning the new character data.

63. The image communication system in accordance with claim 58, comprising a character management center including a plurality of character data; wherein
said predetermined communication terminal further includes:
an emotion movement pattern setting circuit for rewriting the emotion movement patterns stored in said emotion movement pattern storage responsive to a command from the user, and
a character manager for instructing the character management center to download character data responsive to a command by the user to hold new character data downloaded from the character management center;
said image compositor holding a parameter concerning the predetermined character data;
said character manager being responsive to downloading of the new character data sending to the basic emotion generator a basic emotion parameter for updating the basic emotion identification and the basic emotion data stored in said basic emotion generator to a basic emotion identification and basic emotion data relating to the new character data, sending to said emotion movement pattern setting circuit an emotion movement pattern designating signal for storing an emotion movement pattern relating to the new character data in said emotion movement pattern storage, and sending to said image compositor a character data parameter updating a parameter concerning the predetermined character data to a parameter concerning the new character data.

64. The image communication system in accordance with claim 59, comprising a character management center including a plurality of character data; wherein
said predetermined communication terminal further includes:
an emotion movement pattern setting circuit for rewriting the emotion movement patterns stored in said emotion movement pattern storage, responsive to a command from the user; and
a character manager responsive to a command from the user instructing the character management center to download character data to hold new character data downloaded from the character management center;
said image compositor holding a parameter concerning the predetermined character data;
said character manager being responsive to downloading of the new character data parameter sending to said viewing point controller and said background image selector a control parameter for updating the viewing point control identification and the viewing point control parameter and/or a background image identification and a background image parameter, stored in said viewing point controller and/or in said background image selector, to a viewing point control identification and a viewing point control parameter and/or a background image identification and a background image parameter matched to the new character data, sending to the emotion movement pattern setting circuit an emotion movement pattern designating signal for storing an emotional movement pattern relating to the new character data in said emotion movement pattern storage, and sending to said image compositor a character data parameter updating a parameter concerning the predetermined character data to a parameter concerning the new character data.

65. The image communication system in accordance with claim 60, comprising a character management center including a plurality of character data; wherein
said predetermined communication terminal further includes:
an emotion movement pattern setting circuit for rewriting the emotion movement patterns stored in said emotion movement pattern storage, responsive to a command from the user; and
a character manager responsive to a command from the user instructing the character management center to download character data to hold new character data downloaded from the character management center;
said image compositor holding a parameter concerning the predetermined character data;
said character manager being responsive to downloading of the new character data parameter sending to said viewing point controller and said background image selector a control parameter for updating the viewing point control identification and the viewing point control parameter and/or a background image identification and a background image parameter, stored in said viewing point controller and/or in said background image selector, to a viewing point control identification and a viewing point control parameter and/or a background image identification and a background image parameter matched to the new character data, sending to the emotion movement pattern setting circuit an emotion movement pattern designating signal for storing an emotional movement pattern relating to the new character data in said emotion movement pattern storage, and sending to said image compositor a character data parameter updating a parameter concerning the predetermined character data to a parameter concerning the new character data.

66. The image communication system in accordance with claim 52, further comprising:
a chat server for setting up a chat session with said communication terminal;
said predetermined communication terminal further comprising:
a text chat client circuit having a chat function for setting up a chat session with said chat server via said communication circuit and the IP network and for transmitting or receiving text data to or from said chat server; and
a filter for sending transmission text data from text input device to said text chat client circuit, when the user inputs the transmission text data for transmission to said chat server to said text input device, for extracting text data indicating a message part out of the transmission text data to send the so extracted text data to said image compositor.

67. The image communication system in accordance with claim 66 wherein said chat server includes a session manager for managing and processing the chat session;
a filter for referencing the chat session for extracting a user identification identifying a user of predetermined chat data and message data of the user;
an emotion analyzer for detecting a predetermined emotion parameter based on the message data; and
a control letter generator for generating a predetermined control code relating to the predetermined emotion parameter;
said session manager merging the predetermined control code to the predetermined chat data to send the predetermined chat data to the communication terminal taking part in the chat session;
said predetermined communication terminal extracting the predetermined control code from chat data received from said chat server to send the predetermined control code to said movement controller;
said movement controller acquiring the predetermined emotion parameter based on the predetermined control code.

68. A chat server arranged on an image communication system employing a plurality of communication terminals for transmitting or receiving voice and image signals over a communication network, such as IP (Internet Protocol) network, to communicate with one another, said chat server setting up a chat session with said communication terminals, said chat server comprising:
a session manager for managing and processing the chat session;
a filter for referencing the chat session for extracting a user identification identifying a user of predetermined chat data and message data of the user;
an emotion analyzer for detecting a predetermined emotion parameter based on the message data; and
a control letter generator for generating a predetermined control code matched to the predetermined emotion parameter;
said session manager merging the predetermined control code to the predetermined chat data to send the predetermined chat data to said communication terminal taking part in the chat session.
